(19) United States
(12) Patent Application Publication
(10) Pub. No.: US 2019/0315146 A1
(43) Pub. Date: Oct. 17, 2019

(54) Sticker, and an insert for a book

(71) Applicant: Chi Lam Leung, Bristol (GB)

(72) Inventor: Chi Lam Leung, Bristol (GB)

(21) Appl. No.: 15/969,771

(22) Filed: May 2, 2018

Related U.S. Application Data
(60) Provisional application No. 62/490,626, filed on Apr. 27, 2017.

(51) Int. Cl. B42D 9/00; B42D 1/00; B42D 5/00

(52) U.S. Cl. CPC B42D 9/004; B42P 2241/08; B42D 5/003; B42D 1/004

(57) ABSTRACT

The invention relates to a sticker, and/or to an insert for a book.

The sticker of the present invention is suitable for inserting into a loop-bound book, and comprises:
(i) a detachable coupling means (preferably elongate such as a finger portion), which can be (i.e. which is capable of being) detachably coupled to the binding of a loop-bound book; and
(ii) a sticky body for attachment to a material, in particular for attachment to a sheet material and/or to a generally planar material, such as a piece (e.g. sheet) of paper or a plastic sheet;
   and wherein the sticker is capable of functioning as an attachment for attaching the material to the loop binding of the book.

The present patent application claims the priority and benefit of U.S. provisional patent application No. 62/490,626 filed on 27 Apr. 2017, GB patent application no. 1712401.7 filed on 1 Aug. 2017, GB patent application no. 1806715.7 filed on 24 Apr. 2018, and GB patent application no. 1806975.7 filed on 28 Apr. 2018, all of which are incorporated herein in their entirety as though fully set forth.

The present invention relates to a sticker, comprising an insert which can be (i.e. which is capable of being) detachably coupled to the binding (binder) of a book, preferably to the binding (binder) of a loop-bound book such as a ring-bound (e.g. open-and-dose ring-bound), spiral-bound (coil-bound), comb-bound, and/or wire-bound book. Preferably, the insert comprises a detachable coupling means and/or an inserting member.

The present invention also relates to an insert, preferably a multifunctional insert, for a loop-bound book such as a spiral-bound book.

As used herein with respect to the present invention, a or the book is preferably a loop-bound book, and/or preferably comprises (e.g. is) a notebook (e.g. a workbook) or a personal organizer. Most preferably, in the present invention, a or the book comprises (e.g. is) a loop-bound notebook (e.g. a loop-bound workbook) or a loop-bound personal organizer.

The present invention also relates to a multipurpose bookmark specifically designed for (and/or adapted for) a book with loop binding (such as a spiral binding); in particular a bookmark designed for (and/or adapted for) a notebook (e.g. a workbook) or a personal organizer.

The present invention also relates to an insert which can be (i.e. which is capable of being) detachably coupled to the binding (binder) of a book, preferably to the binding (binder) of a loop-bound book such as a ring-bound (e.g. open-and-close ring-bound), spiral-bound (coil-bound), comb-bound and/or wire-bound book. Preferably, the insert comprises a detachable coupling means and/or an inserting member. In particular, the insert can be for marking a page of the stack and/or for other uses.

### BACKGROUND OF THE INVENTION

Bookmarks of various sorts have been common for many years. A bookmark is a thin marker or book insert, made from a suitably thin material, such as paper or cardboard, and is placed by a reader inside the book so that it is easy to return to the same book page in the future. It is normally designed to avoid any damage to the book.

Notebooks (for example workbooks) and/or personal organizers are commonly used for the recording of various kinds of information. These include, amongst other things, calendar planners, personal diaries, names and addresses of contacts, notes, and/or task lists; and/or written information recording some or all of the information discussed in a meeting, the discussions which took place in a meeting, and/or decision(s) made in a meeting (in particular minutes or notes of a or the meeting). Notebooks (e.g. workbooks) and/or personal organizers typically comprise pre-printed sheets of paper for writing the information, tab dividers, pockets, pouches or other features. These pre-printed sheets of paper may include ruled lines, calendars, spaces for names and addresses according to the design of the manufacturer. For versatility, personal organizers often include open-and-close ring binders to conveniently bind or detach sheets of material (e.g. paper sheets). For notebooks, the stack of sheet material (e.g. a stack of paper sheets) is sometimes permanently bound together by a binding coil, such that the relative locations of the material are permanently fixed. These rings and coils are examples of binding guides that guide each sheet of material when it is flipped over while allowing the materials to retain their relative positions in the stack. For open-and-close ring binders, these sheets (e.g. paper sheets) can be removed by opening the rings. In contrast, for binding coils, the sheets (e.g. paper sheets) should usually be torn from the binding coil for removal; or alternatively, for binding coils, the sheets (e.g. paper sheets) should usually be torn off and/or removed along a line of weakness, e.g. a perforated line, in the sheet which is typically generally parallel to and/or is typically adjacent to the binding coil.

In order to provide greater flexibility, dividers and other components for these personal organizers and/or notebooks which are meant to be detachably used should preferably have features that allow them to be conveniently attached to or removed from the binder. This allows customization because the various components can then be releasably coupled to the binder in any location within the stack of material and are reusable by moving them to another location.

U.S. Pat. No. 2,633,372 A, titled “Bookmark”, relates to a bookmark which, allegedly, may be easily and quickly applied to old or to new books, without defacing or damaging the same, or otherwise detracting from the appearance, form or size of the book.

U.S. Pat. No. 1,961,527 A, titled “Bookmark”, relates generally to reading accessories, and particularly to a book mark arranged for novel association with a book. Also, it discloses a body member for insertion between the inner edges of the pages and the back of the binding of a book, and flexible members extending from the body member and arranged for placing between selected pages of the book, to mark a plurality of places in the book.

CN 102463763 A, titled “Precise bookmark”, discloses a precise bookmark, comprising a bookmark, wherein a V-shaped clamping plate is arranged on the upper part of the bookmark; an indicating bar is in sliding connection with the bookmark; the bookmark is fixed on the top of a book page after reading, the indicating bar is slid to the unread row, and the book is closed; and when the book is opened again, less time can be used to find out the unread paragraph. The precise bookmark disclosed by the invention is alleged to have the advantages of a simple structure and convenience for reading.

U.S. Pat. No. 2,448,611 A, titled “Magnetic bookmark”, discloses a bookmark having magnetic means secured thereon for placement on opposite sides of the page to be marked, the magnet elements being attracted to each other whereby the mark will be detachably secured to the page. These magnetic elements are not very practical.

WO 2006/118546 A2 and US 2009/0311037 A1 (both Chi Lam Leung) disclose an insert for detachable coupling to a plurality of spaced binding guides holding a stack of sheet material, comprising: (i) a flexible body; and (ii) a hook comprising a finger portion extending substantially parallel to a side of the flexible body to form an elongated slit with the flexible body that is configured for slidably receiving a binding guide through an opening of the elongated slit whereby to engage the binding guide in a position along the elongated slit; wherein the finger portion extends from near an end portion of the side of the flexible body in a direction away from said end portion such that the opening of the elongated slit faces away from said end portion. Preferably, the insert of WO 2006/118546 A2 also includes a second hook comprising a second finger portion extending substantially parallel to said side of the flexible body to form a second elongated slit with the flexible body that is configured for slidably receiving a second binding guide through an opening of the second elongated slit whereby to engage the second binding guide in a position along the second elongated slit. Preferably, the opening of the second elongated slit faces away from the opening of the first elongated slit.

Preferably, the insert disclosed in WO 2006/118546 A2 also includes a flange portion projecting from the second hook in the direction of the first hook for engaging another binding guide when the first binding guide is engaged in the first elongated slit. Page 9 of the Detailed Description of WO 2006/118546 A2 discloses an example of this flange arrangement and its function as follows: “ . . . The flexible body 12 is then unflexed, and the result will be that one binding guide 36a is received by the first elongated slit 18 of the first hook 16 and another binding guide 36b is received by the flange portion 31 of the second hook 26. As can be seen from FIG. 1, the insert 10 is prevented from being separated from the binding guides 36 by the finger portion 22 of the first hook 16 and the flange portion 31 of the second hook 24.” However, it has now been found that this flange portion 31 of the second hook 26, which projects and/or faces in the opposite (reverse-facing) direction to that of the main finger portion of the second hook 26, is unnecessary and in some cases may be disadvantageous.

In the insert disclosed in WO 2006/118546 A2, the flexible body preferably further comprises an attachment portion (specifically, a clip-like flap 32) cut from the flexible body which is pliable for receiving and attaching objects (such as loose pieces of paper) between the attachment portion (e.g. flap 32) and the flexible body (e.g. 12). However, this is not a very secure means of attachment; the pieces of paper can easily fall out of the flap 32.

### BRIEF SUMMARIES AND DETAILED DESCRIPTION OF THE INVENTION

Compared to the unsecure attachment portion (flap 32) of the flexible body 12 of the insert 10 disclosed in pages 5-12 and the Figures of WO 2006/118546 A2, there is a need for a more efficient and/or secure and/or convenient means of attaching loose pieces of paper, envelopes or other flat objects to and/or within a loop-bound book, in particular to and/or within a spiral-bound (coil-bound), ring-bound (e.g. open-and-close ring-bound), comb-bound and/or wire-bound book.

Also, in general, improved and/or alternative versions of the insert(s) disclosed in WO 2006/118546 A2 would be desirable.

In particular, it would be desirable to have an insert and/or a bookmark and/or a device, for marking a page of a book (preferably a loop-bound book, in particular a spiral-bound (coil-bound), ring-bound (e.g. open-and-dose ring-bound), comb-bound and/or wire-bound book; in particular a loop-bound (e.g. spiral- or ring-bound) notebook (e.g. workbook) or personal organizer),
which has improved convenience and/or design, and/or
which is for indicating information relating to (e.g. the number of, and/or the subject-matter, content and/or title of) a page of a book marked by the insert, bookmark and/or device, and/or
which may be easily and/or efficiently manufactured and/or marketed, and/or
which is of a durable and/or reliable construction, and/or
which has multiple functions and/or uses, and/or
which functions both as a bookmark and for jotting points (e.g. functioning as a note pad or paper), and/or
which functions both to mark a page of a loop-bound book (in particular a spiral-bound book) and also as a geometrical measuring device, preferably a ruler and/or a protractor.

### THE FIRST ASPECT OF THE INVENTION, AND SOME PREFERRED AND/OR PARTICULAR FEATURES OF ALL ASPECTS AND/OR EMBODIMENTS OF THE INVENTION

Compared to the unsecure attachment portion (flap 32) of the flexible body 12 of the insert 10 disclosed in pages 5-12 and the Figures of WO 2006/118546 A2, there is a need for a more efficient and/or secure means of attaching loose pieces of paper, envelopes or other flat objects to and/or within a loop-bound book, in particular to and/or within a spiral-bound (coil-bound), ring-bound (e.g. open-and-dose ring-bound), comb-bound and/or wire-bound book.

Accordingly, a first aspect of the present invention provides a sticker suitable for inserting into a book (preferably suitable for inserting into a loop-bound book e.g. a spiral- or ring-bound book), comprising:

(i) a detachable coupling means (in particular an inserting member), which can be (i.e. which is capable of being) detachably coupled to the binding (binder) of a loop-bound book; and

(ii) a sticky body for attachment to a material (wherein the material preferably comprises a sheet and/or a generally planar material; or more preferably comprises a piece (in particular a sheet) of paper, an envelope and/or a plastic sheet);

wherein the sticker is capable of functioning as an attachment for attaching the material to the loop binding of the book.

A used herein, for any and/or all aspects and/or embodiments of the present invention, the terms “loop binding”, “loop binder”, “loop-bound” or similar terms, should be understood as meaning a binding system (or bound by a binding system) which loosely joins a sheaf or stack of pages (preferably pages of a book), wherein the binding system loops around and/or through holes (in particular sequential holes) on one edge of the pages. The binding system preferably comprises loops, typically a plurality of loops. The loops may be in a spiral (preferably a continual spiral); or the loops may be as separate, individual loops. Preferably, the loops are curved in some manner; and more preferably the loops are made from circles, rings, spirals, straight lines, and/or ellipses, and/or are made from portions of circles, rings, spirals, straight lines, and/or ellipses. For example, “ring binding”, typically as or in a multi ring binding system and/or a ring binder such as a two-ring or three-ring binder (preferably a binder having a plurality of, more preferably two or three, openable and closable rings; and/or preferably an open-and-dose ring binder), would be included as a preferred embodiment of “loop binding”. Other examples, which are alternative and/or additional preferred embodiments of “loop binding”, include comb binding, spiral binding (also called coil binding), and/or wire binding.

Preferably, the detachable coupling means (such as the inserting member) is elongate and/or narrow; and more preferably is elongate.

Preferably, the detachable coupling means (preferably elongate and/or preferably the inserting member) continues (i.e. extends) from, or from adjacent to, a top portion of the body.

Preferably, the detachable coupling means (preferably elongate and/or preferably the inserting member) is aligned generally parallel to the body and/or to a side (preferably an adjacent side) of the body.

Preferably, the detachable coupling means (preferably elongate and/or preferably the inserting member) and the body together form a gap between the detachable coupling means (preferably the inserting member) and the body, wherein the gap is adapted to receive (and/or is adapted to be inserted inside) the loop binding of the book (and/or wherein the gap is adapted so that a or the loop binding of a or the book can be inserted inside the gap).

Preferably, the detachable coupling means (preferably the inserting member) is elongate and comprises a finger portion which is capable of being detachably coupled to the binding of a loop-bound book. Preferably, the finger portion is aligned generally parallel to the body and/or to a side of the body; and/or preferably, the finger portion is connected (preferably integrally) to the body via a stem portion (in which case, preferably, a base of the stem portion extends in a direction generally away from, in particular generally perpendicular to and away from, the body, such as generally away from the side e.g. adjacent side of the body).

Particularly preferably, the detachable coupling means is elongate and comprises a finger portion which is capable of being detachably coupled to the binding of a loop-bound book, wherein:
the finger portion is aligned generally parallel to the body and/or to a side (particularly an adjacent side) of the body; and
the finger portion of the elongate detachable coupling means and the body together form a gap between the finger portion and the body, wherein the gap is adapted to receive the loop binding (preferably a spiral binding) of the book (and/or wherein the gap is adapted so that the loop binding (preferably a spiral binding) of the book can be inserted inside the gap); and
the finger portion has a width of from 1.5 to 6 mm (preferably from 1.5 to 5 mm or from 2 to 5 mm, more preferably from 2 to 4.5 mm or from 2 to 4 mm, even more preferably from 2.5 to 4 mm or from 2.5 to 3.5 mm, or most preferably about 3 mm);

and/or (preferably and)
the finger portion has a length of from 5 to 45 mm or from 5 to 40 mm or from 5 to 30 mm, preferably from 7 to 45 mm or from 7 to 40 mm or from 7 to 30 mm, more preferably from 9 to 40 mm or from 9 to 30 mm or from 9 to 25 mm, in particular from 12 to 30 mm or from 12 to 25 mm, more particularly from 14 to 25 mm, or most particularly from 16 to 25 mm, such as about 20 mm;

wherein the length of the finger portion is measured, in a direction parallel to a longitudinal axis of the finger portion and/or in a direction parallel to an adjacent edge of the body, from (i) an outer tip of the finger to (ii) the innermost portion of the gap between the finger portion and the body (that is, or and/or, from (i) an outer tip of the finger to (ii) to the point where an inner edge of the finger portion, or an inner edge of a or the stem portion connecting the finger portion to the body, extends and/or projects from the body).

In the particularly preferred embodiment disclosed in the paragraph(s) immediately hereinabove, more preferably, the finger portion is connected to the body via a stem portion; in which case, even more preferably, a base of the stem portion extends in a direction generally away from, in particular generally perpendicular to and away from, the body, such as generally away from the side e.g. adjacent side of the body. In this preferred stem portion embodiment, preferably, the width of the base of the stem portion is from 2 to 7 mm, preferably from 2 to 6 mm or from 2 to 5 mm, more preferably from 2.5 to 6 mm or from 2.5 to 5 mm or from 2.5 to 4.5 mm, even more preferably from 3 to 5 mm or from 3 to 4.5 mm or from 3 to 4 mm, most preferably about 3.5 mm.

Particularly preferably, an outer edge, of the stem portion and/or the elongate detachable coupling means, (i.e. the edge facing away from a or the gap formed between the finger portion and the body) extends generally away from the body (e.g. generally perpendicularly), at the base of the stem portion, and then forms a curve in a direction generally towards an outer tip of the finger portion. More preferably, the curved outer edge of the stem portion (i) extends generally away from the body (e.g. generally perpendicularly) at the base of the stem portion, and (ii) joins the finger portion (preferably integrally) in a direction generally parallel to the longitudinal axis of the finger portion. This curved outer edge, of the stem portion and/or of the elongate detachable coupling means, has been found to facilitate the smooth insertion of the finger portion (and/or the elongate detachable coupling means) between two adjacent loops of a loop bound book, especially for spiral-bound books.

Particularly preferably, an outer edge, of the stem portion and/or of a or the elongate detachable coupling means, (i.e. the edge facing away from a or the gap formed between (i) the body and (ii) the finger portion and/or the elongate detachable coupling means) is either directed generally towards a or the outer tip of the finger portion, or extends generally away from the body (e.g. generally perpendicularly) and then forms a curve directed generally towards a or the outer tip of the finger portion, or extends generally away from the body (e.g. generally perpendicularly) and then turns at a non-reverse-facing edge so as to be directed generally towards a or the outer tip of the finger portion. This non-reverse-facing shape of the outer edge, of the stem portion and/or of the elongate detachable coupling means, has been found generally to facilitate the smooth insertion of the finger portion (and/or the elongate detachable coupling means) between two adjacent loops of a loop bound book, especially for spiral-bound books.

Particularly preferably, a or the outer edge of the stem portion (and/or of the elongate detachable coupling means) does not include a reverse-facing projection or edge which faces generally away from (in particular substantially directly away from) a or the outer tip of the finger portion. In this way, the (preferably elongate) detachable coupling means (preferably the stem portion and/or the finger portion) does not “snag” on the loop binding, in particular a or the spiral binding, of a book when the detachable coupling means and/or a or the stem portion and/or a or the finger portion is inserted between two adjacent loops in the loop-bound book, especially in a spiral-bound book. This arrangement is an improvement on the arrangement disclosed in the example(s) and figure(s) of WO 2006/118546 A2 which discloses a finger portion with a reverse-facing projection (the second hook 24 has a reverse-facing flange portion 31, in the WO 2006/118546 A2 example(s) and figure(s)), which, though it works reasonably for ring-bounds books, has been found not to work well for spiral-bound (coil-bound) books, as it often “snags” on the spiral binding during insertion and/or removal.

Preferably, the detachable coupling means (preferably the inserting member; and/or preferably the finger portion and/or the stem portion; even more preferably the finger portion and the stem portion) is or are integrally formed with the body.

Preferably, the sticker suitable for inserting into a book (preferably suitable for inserting into a loop-bound book) is made out of a non-brittle and/or flexible plastic, paper or cardboard. More preferably, the sticker suitable for inserting into a book is made out of a non-brittle and/or flexible plastic or paper; even more preferably a non-brittle and/or flexible plastic; yet more preferably a flexible plastic.

In the present invention, a “flexible” material, e.g. a “flexible” plastic, and/or other uses of the term “flexible”, should be interpreted in a way consistent with a or the purpose(s) of the present invention, i.e. or e.g. to enable and/or to facilitate the detachable coupling means (preferably elongate and/or preferably a or the inserting member and/or preferably a or the finger portion) to be flexible enough, and/or to enable and/or to facilitate the body (e.g. of the sticker, insert, book insert, bookmark, divider and/or device) to be flexible enough:
so that a or the gap between the detachable coupling means and the body can receive (ideally easily receive) the loop binding e.g. spiral or ring binding, of the book, and/or
so that the gap can be inserted, ideally easily inserted, inside the loop binding e.g. spiral or ring binding, of the book; and/or
so that the detachable coupling means (preferably elongate and/or preferably a or the inserting member and/or preferably a or the finger portion) can be inserted, ideally easily inserted, into the loop binding e.g. the spiral or ring binding, of the book.

Preferably, the detachable coupling means (preferably elongate and/or preferably the inserting member) and/or the body (in particular the sticky body, or more particularly the body before addition of and/or excluding any adhesive) is or are made out of a non-brittle and/or flexible plastic, paper or cardboard; or more preferably a flexible plastic; or most preferably a flexible plastic as defined herein e.g. hereinbelow.

Particularly preferably, the sticker [and/or the sticker's detachable coupling means and/or the sticker's body (and/or, in other aspects of the invention, the insert, book insert, bookmark, divider and/or device)] is made out of a flexible plastic (which is generally also non-brittle), wherein the flexible plastic comprises:

(i) a flexible polyester [preferably comprising (e.g. being) a flexible poly(ethylene terephthalate) (PET), a flexible poly(butylene terephthalate) (PBT), a flexible poly(trimethylene terephthalate) (PTT), a flexible poly(ethylene naphthalate) (also called poly(ethylene 2,6-naphthalate) or PEN), a flexible poly(hydroxyalkanoate) (PHA), a flexible poly-ε-caprolactone (PCL) (wherein ε is epsilon), a flexible poly(lactic acid) (PLA), a flexible poly(glycolic acid) (PGA, also called polyglycolide), a flexible poly(ethylene succinate) (PESu), a flexible poly(propylene succinate) (PPSu), a flexible poly(butylene succinate) (PBSu), a flexible poly(ethylene adipate) (PEA) and/or a flexible poly(butylene adipate) (PBA)];

(ii) a flexible polyvinyl chloride (PVC) (preferably PVC comprising a plasticizer, typically a phthalate-based plasticizer and/or a poly-ε-caprolactone (PCL) plasticizer);

(iii) a flexible polypropylene (PP);

(iv) a flexible polyethylene (PE)
[preferably:
a flexible high-density polyethylene (HDPE, typically defined by a density of greater than or equal to 0.941 g/cm³),
a flexible medium-density polyethylene (MDPE, typically defined by a density range of from 0.926 to 0.940 g/cm³),
a flexible low-density polyethylene (LDPE, typically defined by a density range of from 0.910 to 0.940 g/cm³),
a flexible linear low-density polyethylene (LLDPE, typically a substantially linear polyethylene and/or defined by a density range of from 0.915 to 0.925 g/cm³; typically the polymer containing some short-chain branches, preferably some C₁-C₈alkyl or C₂-C₆alkyl branches; and/or the LLDPE typically having been made by copolymerization of ethylene with short-chain (preferably C₄-C₈) alpha-alkenes (1-alkenes) such as 1-butene, 1-hexene and/or 1-octene), and/or
a flexible very-low-density polyethylene (VLDPE, defined by a density range of from 0.880 to 0.915 g/cm³; and typically being a substantially linear polymer containing some short-chain branches (preferably some C₁-C₈alkyl or C₂-C₆alkyl, e.g. C₂, C₄ or C₆ alkyl, branches) (more preferably containing high levels of such short-chain branches, e.g. higher levels of short-chain branches than that present in LLDPE), the VLDPE typically having been made by copolymerization of ethylene with short-chain (preferably C₄-C₈) alpha-alkenes (1-alkenes) such as 1-butene, 1-hexene and/or 1-octene];

and/or

(v) a flexible acrylate-polymer-based plastic; preferably comprising a flexible polyacrylic-acid-based plastic, a flexible poly(methyl acrylate) plastic, a flexible polyethyl acrylate) plastic, a flexible poly(methacrylate) plastic and/or a flexible poly(methyl methacrylate) plastic;

and/or

(vi) a flexible copolymer of, or containing, one or more of the polymers (i), (ii), (iii), (iv) and/or (v); in particular a flexible polypropylene-polyethylene copolymer (PP-PE), a flexible ethylene-vinyl acetate (EVA) copolymer, a flexible poly(3-hydroxybutyrate-co-3-hydroxyvalerate) (PHBV), a flexible poly(3-hydroxybutyrate-co-3-hydroxyhexanoate) (PHBH), and/or a flexible poly(butylene adipate-co-terephthalate) (PBAT).

In any or all aspects and/or embodiments of the present invention, a flexible polyester preferably comprises (e.g. is):

[and/or, preferably, a or the sticker, insert, bookmark, divider or other article of the invention, (and/or a or the sticker's detachable coupling means and/or a or the sticker's body), is made out of or from]:
a flexible poly(ethylene terephthalate) (PET), a flexible poly(butylene terephthalate) (PBT), a flexible poly(trimethylene terephthalate) (PTT), a flexible poly(hydroxyalkanoate) (PHA) [preferably a flexible poly(hydroxybutyrate) (PHB), a flexible poly(hydroxyvalerate) (PHV) and/or a flexible poly(hydroxyhexanoate) (PHH), e.g. a flexible PHB, PHV and/or PHH as further defined herein], a flexible poly(lactic acid) (PLA), a flexible poly(glycolic acid) (PGA, also called polyglycolide), a flexible poly(ethylene succinate) (PESu), a flexible poly(propylene succinate) (PPSu), a flexible poly(butylene succinate) (PBSu), and/or a flexible poly(ethylene adipate) (PEA);
and/or comprises (e.g. is) a flexible polyester-containing copolymer; preferably a flexible poly(3-hydroxybutyrate-co-3-hydroxyvalerate) (PHBV), a flexible poly(3-hydroxybutyrate-co-3-hydroxyhexanoate) (PHBH), and/or a flexible poly(butylene adipate-co-terephthalate) (PBAT).

If a biodegradable polyester is desired, e.g. to reduce the negative impact on the land and/or marine environment of discarded articles of the invention (e.g. small stickers according to the invention), then, preferably, in any or all aspects and/or embodiments of the present invention, a flexible polyester preferably comprises (e.g. is):

[and/or, preferably, a or the sticker, insert, bookmark, divider or other article of the invention, (and/or a or the sticker's detachable coupling means and/or a or the sticker's body), is made out of or from]:
a flexible poly-ε-caprolactone (PCL) (wherein ε is epsilon), a flexible poly(hydroxyalkanoate) (PHA) [preferably a flexible poly(hydroxybutyrate) (PHB), a flexible poly(hydroxyvalerate) (PHV) and/or a flexible poly(hydroxyhexanoate) (PHH), e.g. a flexible PHB, PHV and/or PHH as further defined herein], a flexible poly(lactic acid) (PLA) [preferably present as a blend, preferably as a blend with another biodegradable polyester], a flexible poly(glycolic acid) (PGA, also called polyglycolide), a flexible poly(ethylene succinate) (PESu), a flexible poly(propylene succinate) (PPSu), a flexible poly(butylene succinate) (PBSu), a flexible poly(ethylene adipate) (PEA), and/or a flexible poly(butylene adipate) (PBA);
and/or comprises (e.g. is) a flexible poly(3-hydroxybutyrate-co-3-hydroxyvalerate) (PHBV), a flexible poly(3-hydroxybutyrate-co-3-hydroxyhexanoate) (PHBH), and/or a flexible poly(butylene adipate-co-terephthalate) (PBAT).

If a robust, strong, flexible and/or workable (and optionally printable) polyester is desired, then, preferably, in any or all aspects and/or embodiments of the present invention, a flexible polyester preferably comprises (e.g. is):

[and/or, preferably, a or the sticker, insert, bookmark, divider or other article of the invention, (and/or a or the sticker's detachable coupling means and/or a or the sticker's body), is made out of or from]:
a flexible poly(ethylene terephthalate) (PET), a flexible poly(butylene terephthalate) (PBT), a flexible poly(trimethylene terephthalate) (PTT), a flexible poly(ethylene naphthalate) (also called poly(ethylene 2,6-naphthalate) or PEN), a flexible poly(hydroxyalkanoate) (PHA) [preferably as further defined herein, e.g. a flexible PHB, PHV and/or PHH], a flexible poly(ethylene succinate) (PESu), a flexible poly(propylene succinate) (PPSu), and/or a flexible poly(butylene succinate) (PBSu);
and/or (possibly) a flexible poly(lactic acid) (PLA) (preferably present as a blend, preferably as a blend with another polyester which is preferably biodegradable) and/or a flexible poly(ethylene adipate) (PEA) and/or a flexible poly(butylene adipate) (PBA);
and/or comprises (e.g. is) a flexible poly(3-hydroxybutyrate-co-3-hydroxyvalerate) (PHBV), a flexible poly(3-hydroxybutyrate-co-3-hydroxyhexanoate) (PHBH), and/or a flexible poly(butylene adipate-co-terephthalate) (PBAT).

In any or all aspects and/or embodiments of the present invention, a flexible poly(lactic acid) (PLA, also called polylactide) is preferably a flexible poly-(DL-lactic acid) (PDLLA, also called poly-DL-lactide), or a flexible poly-(L-lactic acid) (PLLA, also called poly-L-lactide), or a flexible poly(L-lactide-co-DL-lactide) (PLDLLA) copolymer.

Preferably, in any or all aspects and/or embodiments of the present invention, a flexible poly(lactic acid) (PLA, also called polylactide) is present as a blend, more preferably as a blend with a flexible non-PLA-polyester (preferably a flexible biodegradable non-PLA-polyester), even more preferably as a blend with PBAT, PEA, PBA, PESu, PPSu and/or PBSu. PLA, and also PGA, PCL, PBAT, PEA, PBA, PESu, PPSu and PBSu, are biodegradable polyesters. PLA-PBAT (5-20 wt % PBAT), PLA-PBA (5-20 wt % PBA), and PLA-PBSu (5-20 wt % PBSu) blends have been shown to modify and/or improve the properties of PLA, e.g. exhibiting a higher elongation at break and a slightly lower strength than PLA alone; see e.g. Peng et al., J. Nanomaterials, 2010, vol. 2010, article ID 287082, 8 pages. Preferably, in a blend (of a flexible plastic, polymer and/or polyester) which contains a flexible poly(lactic acid) (PLA) blended with a flexible non-PLA-polyester (in particular with a flexible biodegradable non-PLA-polyester), the blend contains 0.5-50 wt % or 2-40 wt % or 2.5-30 wt % or 5-20 wt % of the non-PLA-polyester, by weight of the PLA-(non-PLA-polyester) blend present.

In any or all aspects and/or embodiments of the present invention, preferably, a flexible poly(hydroxyalkanoate) (PHA) is:

[and/or, preferably, a or the sticker, insert, bookmark, divider or other article of the invention, (and/or a or the sticker's detachable coupling means and/or a or the sticker's body), is made out of or from]:
a flexible poly(hydroxybutyrate) (PHB) [more preferably a flexible poly(3-hydroxybutyrate) (P3HB) (preferably a flexible poly((R)-3-hydroxybutyrate) (P(R)3HB)) and/or a flexible poly(4-hydroxybutyrate) (P4HB); even more preferably a flexible P3HB comprising 1000 to 30000 3-hydroxybutyrate monomers and/or a flexible P4HB comprising 1000 to 30000 4-hydroxybutyrate monomers, and/or even more preferably a flexible P3HB or P4HB having an average (preferably number average) molecular weight of from 0.03 to 100 MDa, from 0.2 to 60 MDa, from 0.5 to 40 MDa, or from 1 to 30 MDa (Da=Daltons, MDa=mega-Daltons)];
a flexible poly(hydroxyvalerate) (PHV) [more preferably a flexible poly(3-hydroxyvalerate) (P3HV), still more preferably a flexible poly((R)-3-hydroxyvalerate) (P(R)3HV)];
a flexible poly(hydroxyhexanoate) (PHH) [more preferably a flexible poly(3-hydroxyhexanoate) (P3HH), in particular a flexible poly((R)-3-hydroxyhexanoate)];
a flexible poly(hydroxyoctanoate) (PHO);
a flexible poly(3-hydroxybutyrate-co-3-hydroxyvalerate); and/or
a flexible poly(3-hydroxybutyrate-co-3-hydroxyhexanoate).

Poly(hydroxyalkanoates) (PHA's), in particular the ones listed above, are useful biodegradable polyesters, and, in general, many of them have a useful balance of properties, e.g. regarding flexibility, strength, glass-transition temperature and/or melting temperature.

More preferably, in the invention, a flexible poly(hydroxyalkanoate) (PHA) is:

[and/or, more preferably, a or the sticker, insert, bookmark, divider or other article of the invention, (and/or a or the sticker's detachable coupling means and/or a or the sticker's body), is made out of or from]:
a flexible poly(hydroxybutyrate) (PHB) [more preferably a flexible P3HB (in particular a flexible P(R)3HB) and/or a flexible P4HB, and/or as further defined herein];
a flexible poly(hydroxyvalerate) (PHV) [more preferably a flexible poly(3-hydroxyvalerate) (P3HV), still more preferably a flexible P(R)3HV]; and/or
a flexible poly(3-hydroxybutyrate-co-3-hydroxyvalerate).

In any or all aspects and/or embodiments of the present invention, a flexible poly(propylene succinate) (PPSu), which can be poly(1,3-propylene succinate) or poly(1,2-propylene succinate), and/or a flexible poly(ethylene succinate) (PESu), and/or a flexible poly(butylene succinate) (PBSu), preferably has an average (preferably number average) molecular weight of from 2000 to 2,000,000 g/mol (Daltons), preferably from 5000 to 500,000 g/mol (Daltons), more preferably from 10,000 to 200,000 g/mol (Daltons). The poly(alkylene succinates) PESu, PPSu and PBSu are useful biodegradable polyesters (PPSu is most preferred, as it has the fastest biodegradation rate of the three), and generally and/or often PESu, PPSu and/or PBSu have a useful balance of properties, e.g. regarding flexibility, strength, glass-transition temperature and/or melting temperature. In one preferred embodiment, a flexible PPSu, PESu and/or PBSu is present as a blend with a flexible polylactide (PLA); in which case, preferably, the polymer (polyester) blend contains 0.5-50 wt % or 2-40 wt % or 2.5-30 wt % or 5-20 wt % of (PPSu, PESu and/or PBSu) by weight of the PLA-(PPSu, PESu and/or PBSu) blend present (see e.g. Peng et al., J. Nanomaterials, 2010, vol. 2010, article ID 287082, 8 pages).

In any or all aspects and/or embodiments of the present invention, a flexible ethylene-vinyl acetate (EVA) copolymer is typically a flexible EVA copolymer containing from 0.001 to 30% or from 0.01 to 30% of copolymerized vinyl acetate, preferably from 0.01 to 15% of copolymerized vinyl acetate, more preferably from 0.01 to 5% or from 0.05 to 5% or from 0.1 to 4% of copolymerized vinyl acetate. Preferably, the percentages of copolymerized vinyl acetate stated are % by weight of the ethylene-vinyl acetate copolymer present.

In any or all aspects and/or embodiments of the present invention, preferably, a flexible poly(3-hydroxybutyrate-co-3-hydroxyvalerate) (PHBV) is:

[and/or, preferably, a or the sticker, insert, bookmark, divider or other article of the invention, (and/or a or the sticker's detachable coupling means and/or a or the sticker's body), is made out of or from]:

a flexible PHBV containing from 0.3 to 50% or from 0.5 to 40%, more preferably from 1 to 30% or from 2 to 25%, even more preferably from 2 to 20% or from 5 to 20%, typically about 1%, about 2%, about 5%, about 8% or about 12%, of copolymerized 3-hydroxyvalerate by weight of the poly(3-hydroxybutyrate-co-3-hydroxyvalerate) present.

In any or all aspects and/or embodiments of the present invention, preferably, a flexible poly(3-hydroxybutyrate-co-3-hydroxyhexanoate) (PHBH) is:

[and/or, preferably, a or the sticker, insert, bookmark, divider or other article of the invention, (and/or a or the sticker's detachable coupling means and/or a or the sticker's body), is made out of or from]:

a flexible PHBH containing from 0.3 to 50% or from 0.5 to 40%, more preferably from 1 to 30% or from 2 to 25%, even more preferably from 2 to 20% or from 5 to 20%, typically about 1%, about 2%, about 5%, about 8% or about 12%, of copolymerized 3-hydroxyhexanoate by weight of the poly(3-hydroxybutyrate-co-3-hydroxyhexanoate) present.

In any or all aspects and/or embodiments of the present invention, a flexible poly(butylene adipate-co-terephthalate) (PBAT) is preferably a flexible PBAT obtainable from and/or synthesized from adipic acid, (terephthalic acid and/or preferably dimethyl terephthalate), and 1,4-butane diol (see e.g. the Wikipedia entry for this polymer). PBAT is a useful biodegradable polyester. Preferably, a flexible poly(butylene adipate-co-terephthalate) (PBAT) can contain from 1 to 99 wt % or from 5 to 95 wt % or from 10 to 90 wt % or from 20 to 80 wt % or from 30 to 75 wt % of copolymerized butylene adipate by weight of PBAT present. In one preferred embodiment, a flexible poly(butylene adipate-co-terephthalate) (PBAT) is present as a blend of a flexible polylactide (PLA) and a flexible poly(butylene adipate-co-terephthalate), which more preferably contains 0.5-50 wt % or 2-40 wt % or 2.5-30 wt % or 5-20 wt % of PBAT by weight of the PBAT-PLA blend present (see e.g. Jiang et al., Biomacromolecules, 2005, vol. 7(1), 199; and/or Peng et al., J. Nanomaterials, 2010, vol. 2010, article ID 287082, 8 pages).

More particularly preferably, in the first, second and/or third aspects of the invention and/or in embodiments thereof, the sticker [and/or the sticker's detachable coupling means and/or the sticker's body (and/or, in other aspects of the invention, the insert, book insert, bookmark, divider and/or device)] is made out of a flexible plastic (which is preferably also non-brittle), wherein the flexible plastic comprises:

(i) a flexible polyester (preferably a flexible PET, a flexible PBT, a flexible PTT, a flexible PEN, a flexible polyhydroxyalkanoate (PHA) (in particular a flexible PHB, a flexible PHV and/or a flexible PHH), a flexible PCL, a flexible PLA, a flexible PGA, a flexible PESu, a flexible PPSu, a flexible PBSu, a flexible PEA, and/or a flexible PBA);

(ii) a flexible polyvinyl chloride (PVC) (preferably PVC comprising a plasticizer, typically a phthalate-based plasticizer and/or a PCL plasticizer);

(iii) a flexible polypropylene (PP); and/or

(iv) a flexible polyethylene (PE); and/or

(vi) a flexible copolymer of, or containing, one or more of the polymers (i), (ii), (iii) and/or (iv) [in particular a flexible polypropylene-polyethylene copolymer (PP-PE), a flexible ethylene-vinyl acetate (EVA) copolymer, a flexible poly(3-hydroxybutyrate-co-3-hydroxyvalerate) (PHBV), a flexible poly(3-hydroxybutyrate-co-3-hydroxyhexanoate) (PHBH), and/or a flexible poly(butylene adipate-co-terephthalate) (PBAT)].

Even more particularly preferably, in the first, second and/or third aspects of the invention and/or in embodiments thereof, the sticker [and/or the sticker's detachable coupling means and/or the sticker's body (and/or, in other aspects of the invention, the insert, book insert, bookmark, divider and/or device)] is made out of a flexible plastic (which is preferably also non-brittle), wherein the flexible plastic comprises:

(i) a flexible PET, a flexible PBT, a flexible PTT, a flexible PEN, a flexible polyhydroxyalkanoate (PHA) (in particular a flexible PHB, a flexible PHV and/or a flexible PHH), a flexible PLA, a flexible PESu, a flexible PPSu, a flexible PBSu, and/or a flexible PEA;

(ii) a flexible polyvinyl chloride (PVC) (preferably PVC comprising a plasticizer, typically a phthalate-based plasticizer and/or a PCL plasticizer);

(iii) a flexible polypropylene (PP); and/or

(vi) a flexible copolymer of, or containing, one or more of the polymers (i), (ii) and/or (iii) (preferably a flexible polypropylene-polyethylene copolymer (PP-PE), a flexible poly(3-hydroxybutyrate-co-3-hydroxyvalerate) (PHBV), a flexible poly(3-hydroxybutyrate-co-3-hydroxyhexanoate) (PHBH), and/or a flexible poly(butylene adipate-co-terephthalate) (PBAT)),

Yet more particularly preferably, in the first, second and/or third aspects of the invention and/or in embodiments thereof, the sticker [and/or the sticker's detachable coupling means and/or the sticker's body (and/or, in other aspects of the invention, the insert, book insert, bookmark, divider and/or device)] is made out of a flexible plastic (which is preferably also non-brittle), wherein the flexible plastic comprises:

(i) a flexible PET, a flexible PBT, a flexible PTT, a flexible PEN, a flexible polyhydroxyalkanoate (PHA) (in particular a flexible PHB, a flexible PHV and/or a flexible PHH), a flexible PLA, a flexible PESu, a flexible PPSu, a flexible PBSu, and/or a flexible PEA; and/or

(ii) a flexible polyvinyl chloride (PVC) (preferably PVC comprising a plasticizer, typically a phthalate-based plasticizer and/or a PCL plasticizer); and/or

(vi) a flexible copolymer of, or containing, one or more of the polymers (i) and/or (ii) (preferably a flexible poly(3-hydroxybutyrate-co-3-hydroxyvalerate) (PHBV), a flexible poly(3-hydroxybutyrate-co-3-hydroxyhexanoate) (PHBH), and/or a flexible poly(butylene adipate-co-terephthalate) (PBAT)).

Most preferably, in the first, second and/or third aspects of the invention and/or in embodiments thereof, the sticker [and/or the sticker's detachable coupling means and/or the sticker's body (and/or, in other aspects of the invention, the insert, book insert, bookmark, divider and/or device)] is made out of a flexible plastic (which is preferably also non-brittle), wherein the flexible plastic comprises a flexible polyethylene terephthalate (PET).

It has been found that, e.g. for the sticker invention and/or in other aspects of the invention, PET (and presumably also PBT and PTT and PEN) is a more preferred plastic than PP, based on PET being more workable than, and/or more able to be printed upon, than PP. PVC is likely to be approximately as good as PET in a technical sense, but PET is cheaper than PVC which may be important for disposable and/or low-cost stationery-type goods.

On the other hand, PET (and PEN, and presumably also PBT and PTT) is or are often very persistent in (i.e. can take a long time to biodegrade in) natural (e.g. marine) environments. These essentially-non-biodegradable polyesters, typified by PET (a great amount of which is present in marine environments currently), are at present a major environmental problem and can be damaging to marine life. A sticker according to the first aspect of the present invention, which is usually of a small size and which usually has an extending finger portion and/or inserting member, has the potential to be damaging if & when eaten e.g. by fish, turtles or other marine life; so biodegradable and/or UV-degradable polyesters or polymers or plastics are preferable in an “environmentally friendly or responsible” embodiment of the invention.

Therefore, in another preferred embodiment of the first, second and/or third aspects of the invention, the sticker [and/or the sticker's detachable coupling means and/or the sticker's body (and/or, in other aspects of the invention, the insert, book insert, bookmark, divider and/or device)] is made out of a flexible plastic (e.g. as further defined herein) which generally biodegrades at a faster rate than PET in land and/or marine environments, in particular in typical and/or representative (e.g. most) land and/or marine environments, more particularly in temperate, Mediterranean, semi-equatorial, and/or equatorial climates and/or environments (e.g. land and/or marine environments). Such a biodegradable flexible plastic can for example be made and/or derived from biological materials, preferably from suitable plant-based materials, such as corn husks, grass e.g. switch grass, bark e.g. pine bark, oat hulls, orange peels, potato peels, and/or other agricultural byproducts; alternatively, some biodegradable flexible plastics can be biosynthesized by certain microorganisms e.g. certain bacteria. Several polyesters (typically aliphatic polyesters, e.g. PCL, PHA (e.g. PHB, PHV and/or PHH), PLA, PGA, PESu, PPSu, PBSu, PEA and/or PBA, and/or any other aliphatic polyesters listed herein, and/or the at-least-partially-aliphatic polyester copolymers listed herein (PHBV, PHBH and/or PBAT)) are thought to be generally-suitable, biodegradable (relative to PET), flexible plastics.

Preferably, the body, in particular of the sticker (in particular the sticky body or the body excluding any adhesive), is in the form of a sheet and/or is generally planar. More preferably, the body, in particular of the sticker, is in the form of a thin and/or generally planar sheet and/or more preferably a flexible sheet; even more preferably a sheet of flexible plastic or paper.

Preferably, the body, in particular of the sticker (in particular the sticky body or the body excluding any adhesive), is in the form of a sheet and/or is generally planar; and the body, in particular of the sticker (in particular the sticky body, or in particular the body before addition of any adhesive), has a thickness of from 0.01 to 1 mm, preferably from 0.02 to 1 mm or from 0.02 to 0.5 mm, more preferably from 0.05 to 1 mm or from 0.05 to 0.5 mm or from 0.025 to 0.25 mm, for example from 0.03 to 0.2 mm or from 0.05 to 0.1 mm.

For a good resistance to tearing, it has been found that (at least for a sticker made from PET) the sticker body (in particular the sticky body, or in particular the body before addition of any adhesive) should ideally have a thickness of about 200-350 microns or more, e.g. 300-350 microns or more. Therefore, more preferably, the body, in particular of the sticker (in particular the sticky body, or in particular the body before addition of any adhesive), has a thickness of 0.05 mm or more or from 0.05 to 1 mm or from 0.05 to 0.7 mm or from 0.05 to 0.5 mm, or preferably has a thickness of 0.15 mm or more or from 0.15 to 1 mm or from 0.15 to 0.7 mm or from 0.15 to 0.5 mm, or preferably has a thickness of 0.2 mm or more or from 0.2 to 1 mm or from 0.2 to 0.7 mm or from 0.2 to 0.5 mm or from 0.2 to 0.4 mm, or more preferably has a thickness of 0.25 mm or more or from 0.25 to 1 mm or from 0.25 to 0.7 mm or from 0.25 to 0.5 mm or from 0.25 to 0.4 mm, or even more preferably has a thickness of 0.3 mm or more or from 0.3 to 1 mm or from 0.3 to 0.7 mm or from 0.3 to 0.5 mm or from 0.3 to 0.4 mm, or most preferably from 0.3 to 0.35 mm.

Preferably, the body, in particular of the sticker (in particular the sticky body or the body excluding any adhesive), is in the form of a sheet and/or is generally planar; and the body, in particular of the sticker (in particular the sticky body, or in particular the body before addition of any adhesive), has a height of from 5 to 130 mm and/or (preferably and) a width of from 5 to 130 mm; or more preferably has a height of from 8 to 100 mm and/or (preferably and) a width of from 8 to 100 mm; or even more preferably has a height of from 10 to 70 mm or from 10 to 60 mm and/or (preferably and) a width of from 10 to 70 mm or from 10 to 60 mm; or yet more preferably has a height of from 15 to 60 mm or from 15 to 50 mm and/or (preferably and) a width of from 15 to 60 mm or from 15 to 50 mm; or further more preferably has a height of from 20 to 60 mm or from 20 to 50 mm or from 20 to 40 mm and/or (preferably and) a width of from 20 to 60 mm or from 20 to 50 mm or from 20 to 40 mm.

Preferably, the body, in particular of the sticker (in particular the sticky body or the body excluding any adhesive), contains, or is at least partially (preferably partially) covered by, an adhesive on at least one (preferably one) face of the sheet and/or on at least one (preferably one) face of the generally planar body.

Preferably, the detachable coupling means (preferably the inserting member and/or elongate and/or extending and/or made of flexible plastic; and/or preferably a or the finger portion and/or a or the stem portion; even more preferably a or the finger portion and a or the stem portion), in particular of the sticker of the present invention, is not covered by an adhesive. Preferably, upper and lower faces of the detachable coupling means (preferably the inserting member and/or elongate and/or extending and/or made of flexible plastic; and/or preferably a or the finger portion and/or a or the stem portion; even more preferably a or the finger portion and a or the stem portion), in particular of the sticker of the present invention, are not covered by an adhesive.

Preferably, the adhesive, and/or the application or distribution pattern of the adhesive, on at least one (preferably one) face of the sheet and/or on at least one (preferably one) face of the generally planar body, is such that the sticker can be removed from the material (in particular can be removed from a piece of paper, an envelope or a plastic sheet), preferably substantially without damaging (e.g. without tearing or delaminating) the material.

More preferably, the adhesive, and/or the application or distribution pattern of the adhesive, is such that, after removal from the material, the sticker can then be repositioned and re-stuck to the material (in particular re-stuck to the piece of paper, the envelope or the plastic sheet).

Particularly preferably, the chemical composition of the adhesive, and/or the manner and/or pattern in or by which the adhesive has been applied to and/or distributed around the at least one (preferably one) face of the sheet and/or generally planar body, is such that:
the sticker can be removed from the material (in particular can be removed from a piece of paper, an envelope or a plastic sheet), preferably substantially without damaging (e.g. without tearing or delaminating) the material; and
(optionally, and/or more preferably) the sticker can then be repositioned and re-stuck to the material (in particular re-stuck to the piece of paper, the envelope or the plastic sheet).

Particularly preferably, the adhesive is a pressure-sensitive adhesive and/or is a removeable adhesive. Particularly preferably, the adhesive is a removeable and re-stickable adhesive; and/or the application or distribution pattern of the adhesive achieves said removeability and re-stickability.

In one particularly preferred embodiment of this, the adhesive (in particular as applied to at least one (preferably one) face of the sheet and/or generally planar body of the sticker of the invention) can comprise elastomeric copolymer microspheres, wherein the microspheres comprise 80% or more (preferably from 90% to 99.5% or from 95% to 99%) by weight of at least one polymerized and/or copolymerized C₃-C₁₀ alkyl acrylate ester (preferably at least one polymerized C₄-C₈ alkyl acrylate ester, more preferably iso-octyl acrylate, 4-methyl-2-pentyl acrylate, 2-methylbutyl acrylate, sec-butyl acrylate and/or tert-butyl acrylate), which is preferably oleophilic. Preferably, these microspheres further comprise 20% or less (preferably from 0.5% to 10% or from 1% to 5%) of at least one polymerized and/or copolymerized ionic monomer and/or maleic anhydride. The ionic monomer, which is preferably water-soluble and/or substantially oil-insoluble, preferably comprises sodium, potassium or ammonium methacrylate; ammonium, sodium or potassium acrylate; trimethylamine methacrylimide; 1,1-dimethyl-1-(2,3-dihydroxypropyl)amine methacrylimide; and/or a zwitterionic monomer. An adhesive comprising elastomeric copolymer microspheres of this type was disclosed in U.S. Pat. No. 3,691,140 (S.F. Silver, 3M), incorporated herein by reference as though fully set forth (see e.g. columns 1, 2, 3 and/or 4, and/or Examples 1, 2, 3-10 and 11-15, and/or claims 1-19 of U.S. Pat. No. 3,691,140 for more details). The copolymer microspheres disclosed in U.S. Pat. No. 3,691,140 were used as the repositionable, pressure-sensitive glue which was used at first in the well-known “Post-It”™ notes/pads commercialised by 3M.

In an alternative particularly preferred embodiment of a pressure-sensitive and/or removeable adhesive, the adhesive (in particular as applied to at least one (preferably one) face of the sheet and/or generally planar body of the sticker of the invention) comprises a pattern (preferably a non-repetitive discontinuous pattern) of pressure-sensitive adhesive islands on at least a portion of at least one (preferably one) face of the sheet and/or of the generally planar body (e.g. as disclosed in claim 6 of EP 0 276 557 A1 in the name of 3M, incorporated herein by reference as though fully set forth which adhesive islands are an alternative adhesive pattern that can be used in “Post-It” notes/pads).

In this alternative particularly preferred embodiment, preferably, the sticker, and/or the sheet or body thereof, and/or the adhesive and/or the adhesive islands thereon, is or are further defined as follows:
the pressure-sensitive adhesive is sufficiently adherent to newspaper that, if sheet material having a continuous coating of said adhesive were applied to newspaper, it could not be peeled away at normal removal rates without tearing or delaminating said newspaper:
   wherein the adhesive islands have a thickness of from 0.01 to 0.15 mm (preferably from 0.02 to 0.10 mm); the adhesive islands have at least one other dimension (typically a lateral and/or sheet-planar dimension) no greater than from 0.02 to 1.5 mm (typically the adhesive islands have at least one other dimension of from 0.05 to 0.08 mm); and the adhesive islands occupy from 10 to 85% (preferably from 20 to 60%) of the area over which said adhesive is applied; so as to achieve an adhesion to untreated polyester film of from 8 to 80 grams per centimeter width (more preferably, the force required to remove the sheet material from untreated polyester film is from 10 to 50 g/cm width):
   whereby the at least one (typically one) face of the sheet and/or generally planar body, which is at least partially (preferably partially) covered by the pressure-sensitive adhesive islands, can be adhered to newspaper, allowed to remain in contact with the newspaper for two weeks at room temperature (typically 20-25° C., e.g. 22° C.) and then removed from the newspaper without visibly damaging the newspaper
   (e.g., as disclosed in claims 10, 13, 15, 16 and/or 17 of EP 0 276 557 A1 in the name of 3M, incorporated herein by reference as though fully set forth); and/or
the adhesive is the dried deposition product of an aqueous emulsion (e.g., see claim 14 of EP 0 276 557 A1 in the name of 3M, incorporated herein by reference as though fully set forth); and/or
the non-repetitive pattern of pressure-sensitive adhesive islands is present only adjacent one edge of the sheet or body, the remainder of the sheet or body being substantially free from adhesive islands (e.g., see claim 7 of EP 0 276 557 A1 in the name of 3M); and/or
the pattern of adhesive islands is such that the adhesive island population density in the portion of an adhesive strip adjacent to an adhesive-free portion of the sheet is less than at another portion of the strip (e.g., see claim 8 of EP 0 276 557 A1 in the name of 3M).

Preferably:
the body is in the form of a sheet; more preferably a thin and/or generally planar sheet and/or more preferably a flexible sheet; even more preferably a sheet of flexible plastic or paper; and
the detachable coupling means (preferably elongate and/or preferably the inserting member) extends (i.e. continues) substantially from a top portion of the body in a plane which is generally coplanar with the plane of the sheet.

The flexible plastic is preferably of the type(s) as defined herein, e.g. hereinabove and/or hereinbelow.

Particularly preferably, the sticker of the present invention is substantially as described in Example 6, in particular with reference to FIG. 6.

The first aspect of the invention also provides a method of attaching (preferably removeably attaching) a sticker, as defined in the first aspect of the invention,
to the binding of a loop-bound book; preferably by inserting (more preferably by removeably inserting), into the loop binding of the book, a or the detachable coupling means and/or a or the inserting member (preferably an elongate and/or narrow inserting member e.g. a or the finger portion);

and/or
to a or the material; preferably by attaching (preferably by removeably attaching) the sticky body (e.g. the at least one, preferably one, face of the sticky body at least partially covered with an adhesive e.g. as defined herein) to the material.

Preferably, the material comprises a sheet and/or is a generally planar material; more preferably the material comprises a piece (e.g. sheet) of paper, an envelope and/or a plastic sheet.

The first aspect of the invention also provides a method of making a sticker, as defined in the first aspect of the invention, comprising:

(i) forming a sheet of sticker material from which the stickers are to be made (preferably by rolling and/or by extruding, in particular for flexible and/or thermoplastic plastic material);

(ii) optionally (preferably) masking some areas on a first face of the sheet of sticker material (preferably masking some generally-parallel strips, and/or preferably masking areas of the sheet of sticker material which are destined to form detachable coupling means comprised in the produced sticker(s), on a first face of the sheet of sticker material);

(iii) applying an adhesive (preferably as defined herein) to a or the first face of the sheet of sticker material, in such as way that, by virtue of the method of application of the adhesive to the sheet of sticker material and/or by virtue of the masking of the sheet of sticker material, those areas of the sheet of sticker material which are destined to form detachable coupling means comprised in the produced sticker(s) are substantially not covered by adhesive, and those areas of the sheet of sticker material which are destined to form sticky body(ies) comprised in the produced sticker(s) are substantially covered by adhesive;

(iv) optionally allowing or causing the adhesive to dry at least partially;

(v) optionally removing any masking if present, either before or (preferably) after the drying step (iv); (vi) either before or after the optional masking removing step (v), cutting (preferably die-cutting) the sheet of sticker material into a plurality of (preferably 5 or more of, e.g. 10 or more of, e.g. 50 or more of) stickers as defined in the first aspect of the invention; and

(vii) optionally placing, in particular sticking, the plurality of stickers onto a backing sheet, for example onto a backing sheet made of plastic and/or of paper, preferably plastic or smooth-coated paper.

The method of making can also, in one particular embodiment, comprise forming a or the plurality of stickers into one or more pads, wherein the pads are formed from a plurality of, in particular a superposed plurality of, stickers and/or sheets as defined in the first aspect of the invention.

A second aspect of the invention provides a pad formed from a plurality of, in particular a superposed plurality of and/or a non-superposed plurality of, stickers and/or sheets as defined in the first aspect of the invention. Preferably, the pad is formed from 5 or more or 10 or more stickers and/or sheets, preferably 5 or more or 10 or more superposed stickers and/or sheets, as defined in the first aspect of the invention. Preferably, for the pad invention, the plurality (e.g. the superposed and/or non-superposed plurality) of stickers is in removeable contact with, or (for a superposed plurality of stickers) a bottom sticker (preferably a or the adhesive face thereof) of the superposed plurality of stickers is in removeable contact with, a backing sheet. Preferably, the backing sheet is a backing sheet of plastic and/or of paper (preferably of plastic and/or of smooth-coated paper).

A third aspect of the invention provides a combination, comprising one, two or more stickers, according to a first aspect of the invention,
wherein the one, two or more stickers are attached via the sticky body(ies) thereof to a material; and/or
wherein the one, two or more stickers are attached to (typically inserted into) the binding of a loop-bound book, in particular via a or the detachable coupling means and/or a or the inserting member (preferably via an elongate and/or narrow inserting member e.g. via a or the finger portion).

Preferably, the third aspect of the invention provides a combination, comprising one, two or more stickers, according to a first aspect of the invention,

wherein the one, two or more stickers are attached via the sticky body(ies) thereof to a material;
and wherein, optionally and/or preferably, the one, two or more stickers are also attached to (typically inserted into) the binding of a loop-bound book, in particular via the detachable coupling means and/or the inserting member (preferably via an elongate and/or narrow inserting member e.g. via a or the finger portion).

Preferably, in particular in the first, second and/or third aspects of the invention and/or in embodiments thereof, the material comprises a sheet and/or a generally planar material; more preferably the material comprises a piece of paper, an envelope and/or a plastic sheet.

Preferably, in the second and/or third aspects of the invention and/or in embodiments thereof, the pad and/or the combination comprises one or more preferred (including without limitation more preferred, even or still or yet more preferred, particularly preferred, or most preferred, et al.), particular, optional and/or embodiment features, as described with respect to the sticker and/or method of the first aspect of the invention and/or in embodiments thereof, with all necessary changes being made.

A fourth aspect of the present invention relates to a book insert and/or bookmark, in particular a multipurpose bookmark, specifically designed for (i.e. adapted for) books with a loop binding (preferably spiral, ring, comb or wire binding), such as a notebook (e.g. a workbook) or a personal organizer.

The fourth aspect of the present invention also relates to an insert that can be detachably coupled to the binding (binder), in particular for marking a page of the stack and/or for other uses.

The fourth aspect of the present invention also relates to an insert (e.g. a book insert) and/or a bookmark and/or a divider and/or a device, for marking a page of a book (preferably a loop-bound book, in particular a spiral-bound (coil-bound), ring-bound (e.g. open-and-close ring-bound), comb-bound and/or wire-bound book; in particular a loop-bound (e.g. spiral-bound) notebook (e.g. workbook) or personal organizer),
which has improved convenience and/or design, and/or
which is for indicating information relating to (e.g. the number of, and/or the subject-matter, content and/or title of) a page of a book marked by the insert, bookmark and/or device, and/or
which may be easily and/or efficiently manufactured and/or marketed, and/or
which is of a durable and/or reliable construction, and/or
which has multiple functions and/or uses, and/or
which functions both as a bookmark and for jotting points or notes (in particular functioning as a note pad or paper), and/or
which functions both to mark a page of a loop-bound book (in particular a spiral-bound book) and also as a geometrical measuring device (preferably a ruler and/or a protractor); and/or
which is substantially as described in Example 1 (in particular with reference to FIG. 1), Example 2 (in particular with reference to FIG. 2), Example 3 (in particular with reference to FIG. 3), Example 4 (in particular with reference to FIG. 4), and/or Example 5 (in particular with reference to FIG. 5).

Preferably, the fourth aspect of the present invention provides:

an insert (preferably a book insert, bookmark and/or divider), suitable for using with a loop-bound (e.g. spiral- or ring-bound) book and/or suitable to act as bookmark, comprising:

a body (preferably an elongated, e.g. generally rectangular, body), which is aligned generally parallel to first and second detachable coupling means (in particular generally parallel to first and second inserting members and/or finger portions, preferably generally parallel to first and second, narrow and/or elongate, inserting members and/or finger portions),

wherein a first detachable coupling means (in particular a first inserting member and/or a first finger portion) continues (i.e. extends and/or projects) from at or adjacent to the top of the body, in a direction generally parallel to a side edge of the body, and forming a gap (preferably a narrow gap) between (i) the body of the bookmark and/or of the insert and (ii) the first detachable coupling means and/or the first inserting member and/or the first finger portion, wherein the gap formed by the first detachable coupling means and/or the first inserting member and/or the first finger portion is suitably sized, shaped and/or arranged so as to be capable of being inserted inside (i.e. to be received by) a or the loop binding (e.g. spiral or ring binding) of a or the loop-bound book;

and wherein a second detachable coupling means (in particular a second inserting member and/or a second finger portion) continues (i.e. extends and/or projects) from at or adjacent to the bottom of the body, in a direction generally parallel to a side edge of the body; wherein the second detachable coupling means and/or the second inserting member and/or the second finger portion forms a gap (preferably a narrow gap) between (i) the body of the bookmark and/or of the insert and (ii) the second detachable coupling means and/or the second inserting member and/or the second finger portion, wherein the gap formed by the second detachable coupling means and/or the first inserting member and/or the second finger portion is suitably sized, shaped and/or arranged so as to be capable of being inserted inside (i.e. to be received by) a or the loop binding (e.g. spiral or ring binding) of a or the loop-bound book.

Particularly preferably, for example in addition to the said insert (preferably a or the book insert, bookmark and/or divider) acting as a bookmark for loop-bound (e.g. spiral- or ring-bound) books,

the body of the insert (preferably a or the book insert, bookmark and/or divider) is provided with a plurality of (preferably two or four) slits (preferably diagonal slits in particular four diagonal slits, and/or laterally-directed slits in particular two laterally-directed slits) preferably adjacent to and/or inside of some or all of the corners (preferably adjacent to and/or inside of each of the four corners) of the body, e.g. the elongated and/or generally rectangular body, of the insert.

These slits act as insertion points for [and in a particularly preferable embodiment contain and/or hold in place] a slip (sheet) of paper which can be removeably affixed (preferably via one or more, e.g. all, of the slits) onto the body (e.g. the elongate and/or generally rectangular body) of the insert.

The slip (sheet) of paper is suitable for jotting (writing) points or notes of importance, e.g. to be later recollected, or simply to tabulate points as a reminder list or as a daily planner, etc.

Preferably, the fourth aspect of the present invention also provides:

an insert (typically a book insert and/or a combination of inserts) comprising a plurality of dividers and/or book inserts having a variety of widths, which overlap each other, in a way that serves to act as plurality of dividers, such that the user can see the dividers (preferably such that the user can see each (all) of the dividers) individually; and wherein the plurality of dividers and/or book inserts each have first and second detachable coupling means and/or first and second inserting members and/or first and second finger portions e.g. extending or projecting and/or e.g. as defined herein. This allows the user to use the insert/the combination of inserts/the dividers as an instrument for marking different pages (a plurality of different pages) of the book.

Preferably, the material used for the insert/the combination of inserts/the dividers is a sheet (preferably a plurality of sheets) (e.g. thin sheets) of flexible plastic or paper, or is made of cardboard.

Preferably, in the fourth aspects of the invention and/or in embodiments thereof, the insert (e.g. book insert), the bookmark, the divider and/or the device comprises one or more preferred (including without limitation more preferred, even or still or yet more preferred, particularly preferred, or most preferred, et al.), particular, optional and/or embodiment features, as described with respect to the sticker and/or method of the first aspect of the invention and/or in embodiments thereof, and/or as described with respect to the pad and/or the combination of the second and/or third aspects of the invention and/or in embodiments of any of these, with all necessary changes being made.

Therefore, some preferable features of the fourth aspect of the invention are as follows (with all necessary changes being made, e.g. as appropriate).

Preferably, in the fourth aspect of the invention, the first and/or second detachable coupling means (in particular the first and/or second inserting member(s)) is or are elongate and/or narrow; and more preferably is or are elongate. Preferably, the first and second detachable coupling means comprise first and second finger portions respectively, e.g. as further defined herein and/or which is or are elongate and/or narrow.

Preferably, in the fourth aspect of the invention, the first and/or second detachable coupling means (preferably elongate and/or preferably first and/or second inserting member(s) and/or preferably first and/or second finger portion(s)) continues (i.e. extends) from, or from adjacent to, a top portion of a or the body of the insert (e.g. book insert), the bookmark, the divider and/or the device.

Preferably, in the fourth aspect of the invention, the first and/or second detachable coupling means (preferably elongate and/or preferably first and/or second inserting member(s) and/or preferably first and/or second finger portion(s)) is or are aligned generally parallel to the body and/or to a side (preferably an adjacent side) of a or the body of the insert (e.g. book insert), the bookmark, the divider and/or the device.

Preferably, in the fourth aspect of the invention, the first detachable coupling means (preferably elongate and/or preferably first inserting member(s) and/or preferably first finger portion(s)) and the body, e.g. of the insert or bookmark or divider, together form a first gap between the first detachable coupling means and the body, wherein the first gap is adapted to receive (and/or is adapted to be inserted inside) the loop binding of the book (and/or wherein the first gap is adapted so that a or the loop binding of a or the book can be inserted inside the first gap).

Preferably, in the fourth aspect of the invention, the second detachable coupling means (preferably elongate and/or preferably second inserting member(s) and/or preferably second finger portion(s)) and the body, e.g. of the insert or bookmark or divider, together form a second gap between the second detachable coupling means and the body, wherein the second gap is adapted to receive (and/or is adapted to be inserted inside) the loop binding of the book (and/or wherein the second gap is adapted so that a or the loop binding of a or the book can be inserted inside the second gap).

Preferably, in the fourth aspect of the invention, the first and/or second detachable coupling means (preferably the first and/or second inserting member(s)) is or are elongate and comprise(s) first and/or second finger portion(s) (respectively) which is or are capable of being detachably coupled to the binding of a loop-bound book. Preferably, the first and/or second finger portion(s) is or are aligned generally parallel to the body and/or to a side of the body; and/or preferably, the first and/or second finger portion(s) is or are connected (preferably integrally) to the body via a first and/or second stem portion(s) respectively (in which case, preferably, a base of the stem portion extends in a direction generally away from, in particular generally perpendicular to and away from, the body, such as generally away from the side e.g. adjacent side of the body).

Particularly preferably, in the fourth aspect of the invention, the first and/or second detachable coupling means is or are elongate and comprise(s) first and/or second finger portion(s) respectively which is or are capable of being detachably coupled to the binding of a loop-bound book, wherein:
the first and/or second finger portion(s) is or are aligned generally parallel to the body and/or to a side (particularly an adjacent side) of the body; and
the first and/or second finger portion(s) of the first and/or second elongate detachable coupling means and the body together form first and/or second gaps (respectively) between the first and/or second finger portion(s) and the body, wherein the first and/or second gap(s) is or are adapted to receive the loop binding (preferably a spiral binding) of the book (and/or wherein the first and/or second gap is adapted so that the loop binding (preferably a spiral binding) of the book can be inserted inside the gap); and
the finger portion has a width of from 1.5 to 6 mm (preferably from 1.5 to 5 mm or from 2 to 5 mm, more preferably from 2 to 4.5 mm or from 2 to 4 mm, even more preferably from 2.5 to 4 mm or from 2.5 to 3.5 mm, or most preferably about 3 mm);

and/or (preferably and)
the finger portion has a length of from 5 to 45 mm or from 5 to 40 mm or from 5 to 30 mm, preferably from 7 to 45 mm or from 7 to 40 mm or from 7 to 30 mm, more preferably from 9 to 40 mm or from 9 to 30 mm or from 9 to 25 mm, in particular from 12 to 30 mm or from 12 to 25 mm, more particularly from 14 to 25 mm, or most particularly from 16 to 25 mm, such as about 20 mm;

wherein the length of the finger portion is measured, in a direction parallel to a longitudinal axis of the finger portion and/or in a direction parallel to an adjacent edge of the body, from (i) an outer tip of the finger to (ii) the innermost portion of the gap between the finger portion and the body (that is, or and/or, from (i) an outer tip of the finger to (ii) to the point where an inner edge of the finger portion, or an inner edge of a or the stem portion connecting the finger portion to the body, extends and/or projects from the body).

In the particularly preferred embodiment disclosed in the paragraph(s) immediately hereinabove, more preferably, the first and/or second finger portion(s) is/are connected to the body via first and/or second stem portion(s) respectively; in which case, even more preferably, a base of the respective stem portion extends in a direction generally away from, in particular generally perpendicular to and away from, the body, such as generally away from the side e.g. adjacent side of the body. In this preferred stem portion embodiment, preferably, the width of the base of the stem portion is from 2 to 7 mm, preferably from 2 to 6 mm or from 2 to 5 mm, more preferably from 2.5 to 6 mm or from 2.5 to 5 mm or from 2.5 to 4.5 mm, even more preferably from 3 to 5 mm or from 3 to 4.5 mm or from 3 to 4 mm, most preferably about 3.5 mm.

Particularly preferably, in the fourth aspect of the invention, an outer edge, of the stem portion and/or the first and/or second elongate detachable coupling means, (i.e. the edge facing away from a or the gap formed between the finger portion and the body) extends generally away from the body (e.g. generally perpendicularly), at the base of the stem portion, and then forms a curve in a direction generally towards an outer tip of the finger portion. More preferably, the curved outer edge of the stem portion (i) extends generally away from the body (e.g. generally perpendicularly) at the base of the respective stem portion, and (ii) joins the respective finger portion (preferably integrally) in a direction generally parallel to the longitudinal axis of the finger portion. This curved outer edge, of the respective stem portion and/or of the respective elongate detachable coupling means, has been found to facilitate the smooth insertion of the finger portion (and/or the elongate detachable coupling means) between two adjacent loops of a loop bound book, especially for spiral-bound books.

Particularly preferably, in the fourth aspect of the invention, an outer edge, of the stem portion and/or of a or the 1st and/or 2nd elongate detachable coupling means, (i.e. the edge facing away from a or the gap formed between (i) the body and (ii) the finger portion and/or the elongate detachable coupling means) is either directed generally towards a or the outer tip of the finger portion, or extends generally away from the body (e.g. generally perpendicularly) and then forms a curve directed generally towards a or the outer tip of the finger portion, or extends generally away from the body (e.g. generally perpendicularly) and then turns at a non-reverse-facing edge so as to be directed generally towards a or the outer tip of the finger portion. This non-reverse-facing shape of the outer edge, of the stem portion and/or of the elongate detachable coupling means, has been found generally to facilitate the smooth insertion of the finger portion (and/or the elongate detachable coupling means) between two adjacent loops of a loop bound book, especially for spiral-bound books.

Particularly preferably, in the fourth aspect of the invention, a or the outer edge of the stem portion (and/or of the elongate detachable coupling means) does not include a reverse-facing projection or edge which faces generally away from (in particular substantially directly away from) a or the outer tip of the finger portion. In this way, the (preferably elongate) detachable coupling means (preferably the stem portion and/or the finger portion) does not “snag” on the loop binding, in particular a or the spiral binding, of a book when the detachable coupling means and/or a or the stem portion and/or a or the finger portion is inserted between two adjacent loops in the loop-bound book, especially in a spiral-bound book. This arrangement is an improvement on the arrangement disclosed in the example(s) and figure(s) of WO 2006/118546 A2 which discloses a finger portion with a reverse-facing projection (the second hook 24 has a reverse-facing flange portion 31, in the WO 2006/118546 A2 example(s) and figure(s)), which, though it works reasonably for ring-bounds books, has been found not to work well for spiral-bound (coil-bound) books, as it often “snags” on the spiral binding during insertion and/or removal.

Preferably, in the fourth aspect of the invention, the first and/or second detachable coupling means (preferably first and/or second inserting member(s); and/or preferably first and/or second finger portion(s) and/or first and/or second stem portion(s)); even more preferably first and/or second finger portion(s) and the first and/or second stem portion(s)) is or are integrally formed with the body.

Preferably, in the fourth aspect of the invention, the insert eg book insert, bookmark, divider and/or device suitable for inserting into a book (preferably suitable for inserting into a loop-bound book) is made out of a non-brittle and/or flexible plastic, paper or cardboard. More preferably, the the insert eg book insert, bookmark, divider and/or device suitable for inserting into a book is made out of a non-brittle and/or flexible plastic or paper; even more preferably a non-brittle and/or flexible plastic; yet more preferably a flexible plastic.

Preferably, in the fourth aspect of the invention, the 1st and/or 2nd detachable coupling means (preferably elongate and/or preferably 1st and/or 2nd inserting member(s)) and/or the body e.g. of the insert, bookmark, divider or device, is or are made out of a non-brittle and/or flexible plastic, paper or cardboard; or more preferably a flexible plastic; or most preferably a flexible plastic as defined herein e.g. hereinbelow or hereinabove.

Particularly preferably, in the fourth aspect of the invention, the insert, book insert, bookmark, divider and/or device is made out of paper, or cardboard, or a flexible plastic (which is generally also non-brittle) (preferably flexible plastic), wherein the flexible plastic comprises:

(i) a flexible polyester [preferably comprising (e.g. being) a flexible poly(ethylene terephthalate) (PET), a flexible poly(butylene terephthalate) (PBT), a flexible poly(trimethylene terephthalate) (PTT), a flexible poly(ethylene naphthalate) (also called poly(ethylene 2,6-naphthalate) or PEN), a flexible poly(hydroxyalkanoate) (PHA), a flexible poly-ε-caprolactone (PCL) (wherein ε is epsilon), a flexible poly(lactic acid) (PLA), a flexible poly(glycolic acid) (PGA, also called polyglycolide), a flexible poly(ethylene succinate) (PESu), a flexible poly(propylene succinate) (PPSu), a flexible poly(butylene succinate) (PBSu), a flexible poly(ethylene adipate) (PEA) and/or a flexible poly(butylene adipate) (PBA)];

(ii) a flexible polyvinyl chloride (PVC) (preferably PVC comprising a plasticizer, typically a phthalate-based plasticizer and/or a poly-ε-caprolactone (PCL) plasticizer);

(iii) a flexible polypropylene (PP);

(iv) a flexible polyethylene (PE)
[preferably:
a flexible high-density polyethylene (HDPE, typically defined by a density of greater than or equal to 0.941 g/cm³),
a flexible medium-density polyethylene (MDPE, typically defined by a density range of from 0.926 to 0.940 g/cm³),
a flexible low-density polyethylene (LDPE, typically defined by a density range of from 0.910 to 0.940 g/cm³),
a flexible linear low-density polyethylene (LLDPE, typically a substantially linear polyethylene and/or defined by a density range of from 0.915 to 0.925 g/cm³; typically the polymer containing some short-chain branches, preferably some C₁-C₈alkyl or C₂-C₆alkyl branches; and/or the LLDPE typically having been made by copolymerization of ethylene with short-chain (preferably C₄-C₈) alpha-alkenes (1-alkenes) such as 1-butene, 1-hexene and/or 1-octene), and/or
a flexible very-low-density polyethylene (VLDPE, defined by a density range of from 0.880 to 0.915 g/cm³; and typically being a substantially linear polymer containing some short-chain branches (preferably some C₁-C₈alkyl or C₂-C₆alkyl, e.g. C₂, C₄ or C₆ alkyl, branches) (more preferably containing high levels of such short-chain branches, e.g. higher levels of short-chain branches than that present in LLDPE), the VLDPE typically having been made by copolymerization of ethylene with short-chain (preferably C₄-C₈) alpha-alkenes (1-alkenes) such as 1-butene, 1-hexene and/or 1-octene];

and/or

(v) a flexible acrylate-polymer-based plastic; preferably comprising a flexible polyacrylic-acid-based plastic, a flexible poly(methyl acrylate) plastic, a flexible poly(ethyl acrylate) plastic, a flexible poly(methacrylate) plastic and/or a flexible poly(methyl methacrylate) plastic;

and/or

(vi) a flexible copolymer of, or containing, one or more of the polymers (i), (ii), (iii), (iv) and/or (v); in particular a flexible polypropylene-polyethylene copolymer (PP-PE), a flexible ethylene-vinyl acetate (EVA) copolymer, a flexible poly(3-hydroxybutyrate-co-3-hydroxyvalerate) (PHBV), a flexible poly(3-hydroxybutyrate-co-3-hydroxyhexanoate) (PHBH), and/or a flexible poly(butylene adipate-co-terephthalate) (PBAT).

The flexible plastic can be as further defined in respect of the sticker of the first aspect of the invention.

### GENERAL AND DEFINITIONS, FOR ALL ASPECTS AND/OR EMBODIMENTS OF THE INVENTION

In the present specification, for all aspects and/or embodiments of the invention, any or all preferred and/or advantageous features (including without limitation more preferred, even, still or yet more preferred, particularly preferred, or most preferred features, or similar), any or all particular or suitable or typical or usual features, any or all optional or alternative or embodiment features, and/or any or all features of the examples and/or exemplified embodiments herein, can be combined with any other preferred and/or advantageous features, any other particular or suitable or typical or usual features, any other optional or alternative or embodiment features, and/or any other features of the examples and/or exemplified embodiments herein, in any or all possible combinations. Also, in the present specification, each aspect of the invention can be combined with any preferred and/or advantageous feature(s) (including without limitation more preferred, even, still or yet more preferred, particularly preferred, or most preferred features, or similar), any particular or suitable or typical or usual feature(s), any optional or alternative or embodiment feature(s), and/or any features of the examples and/or exemplified embodiments herein, which apply to or are disclosed in respect of different aspect(s) of the invention, mutatis mutandis (i.e. with any necessary changes made). Each and all such combinations of features are explicitly disclosed herein, and it is intended that any or all of these combinations may be the subject of future patent protection.

A used herein, the terms “loop binding”, “loop binder”, “loop-bound” or similar terms, should be understood as meaning a binding system (or bound by a binding system) which loosely joins a sheaf or stack of pages (preferably pages of a book), wherein the binding system loops around and/or through holes (e.g. sequential holes) on one edge of the pages. The binding system preferably comprises loops, typically a plurality of loops. The loops may be in a spiral (preferably a continual spiral); or the loops may be as separate, individual loops. Preferably, the loops are curved in some manner; and more preferably the loops are made from circles, rings, spirals, straight lines, and/or ellipses, and/or are made from portions of circles, rings, spirals, straight lines, and/or ellipses. For example, “ring binding”, typically as or in a multi ring binding system and/or a ring binder such as a two-ring or three-ring binder (preferably a binder having a plurality of, more preferably two or three, openable and closable rings; and/or preferably an open-and-dose ring binder), would be included as a preferred embodiment of “loop binding”. Other examples, which are alternative and/or additional preferred embodiments of “loop binding”, include comb binding, spiral binding (also called coil binding), and/or wire binding.

As used herein, a “person” means a “human”, and vice versa.

### BRIEF DESCRIPTION OF THE DRAWINGS

FIG. 1 shows a plan view from above of an insert for a spiral bound book of the present invention, as described in Example 1 herein.

FIG. 2 illustrates a plan view from above of an embodiment of the present invention, as described in Example 2 herein.

FIG. 3 illustrates a plan view from above of a further embodiment of the present invention, as described in Example 3 herein.

FIG. 4 illustrates a plan view from above of an insert or bookmark of the present invention, having the additional feature to function as a measuring device (ruler), as described in Example 4 herein.

FIG. 5 illustrates a plan view from above of an insert or bookmark of the present invention, having the additional feature to function as a measuring device (protractor), as described in Example 5 herein.

FIG. 6 depicts a plan view from above of a book insert (sticker) of present invention which functions as an attachment for various materials, as described in Example 6 herein. More particularly, FIG. 6 is a plan view from above of an open loop-bound (e.g. ring-bound, e.g. open-and-dose ring-bound) book, into the binding of which has been inserted a book insert (sticker 209), wherein the sticker is attached to a piece of material (in FIG. 6, the piece of material is an envelope).

### EXAMPLES

The present invention is further described and/or illustrated, by way of example only, in the following non-limiting examples and/or non-limiting embodiments, with reference to the accompanying Figures which are listed and briefly described in the “Brief Description of the Drawings” section hereinabove.

### Example 1

### Insert (100) for Loop-Bound Books

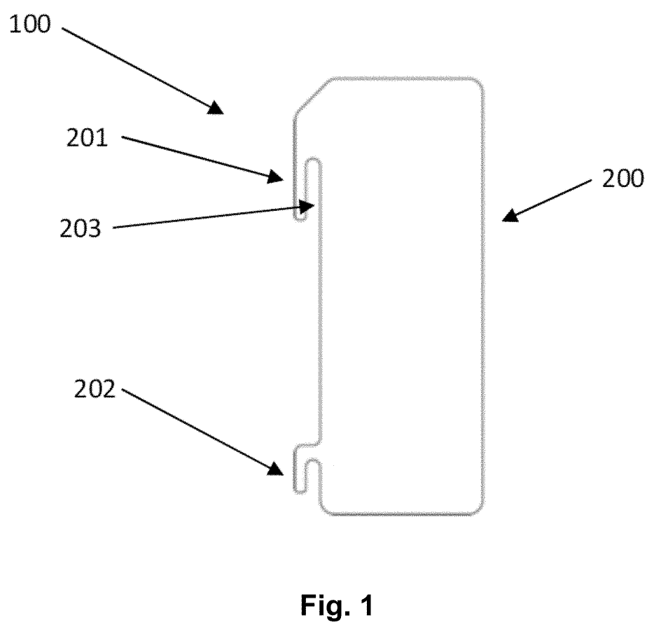

FIG. 1 illustrates an overall view of an insert (100), for loop-bound (e.g. spiral bound) books, notebooks and/or the like, suitable to act as bookmark, comprising an elongated generally rectangular area (body) (200), which is aligned parallel to two narrow (and preferably elongate) inserting members (201) and (202). A first narrow inserting member (201) continues (i.e. extends) from the top of the elongated generally rectangular area (200), forming a very narrow gap (203) between the generally rectangular area (body) (200) of the bookmark (insert 100) and the first inserting member (201), wherein the gap (203) is to be inserted inside (i.e. is to receive) the spiral binding. A second narrow inserting member (202) continues (i.e. extends) from the bottom of the elongated rectangular area (200); also with very narrow gap similar to the gap formed by the first inserting member of the bookmark, and also to be inserted inside (i.e. is to receive) the spiral binding.

### Example 2

### Insert (110) for Loop-Bound Books Having a Plurality of Diagonal Slits (204)

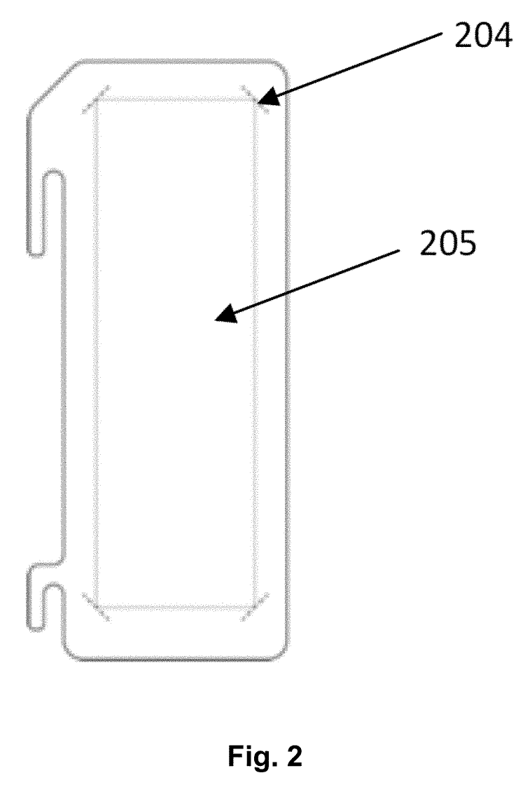

FIG. 2 illustrates an embodiment of an insert (100) of the present invention, wherein the said insert is suitable for using with a loop-bound (e.g. spiral-bound) book. In addition to the said insert acting as a normal bookmark for loop-bound (e.g. spiral-bound) books, the book insert is further provided with a plurality of diagonal slits (204) adjacent to (just inside of) each of the four corners of the of the elongated generally rectangular area (200) of the insert (100). These slits act as insertion points for a slip of paper (205), to be temporarily affixed on the generally rectangular area (200) of the insert (100), for jotting points or notes of importance, to be later recollected or simply to tabulate points as a reminder list or a daily planner, etc.

### Example 3

### Book Insert Comprising a Plurality of Dividers (206)

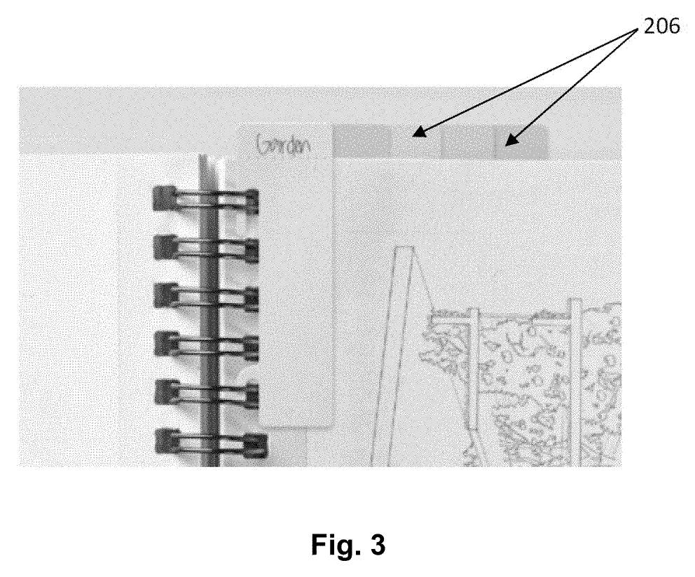

FIG. 3 illustrates an embodiment of an insert (100) of the present invention, wherein the book insert is provided with multiple clips (dividers) of varying colours and having varying width, which overlap each other, in a way that serves to act as plurality of dividers (206), such that the user can see the said dividers (preferably each of the dividers) individually. This allows the user to use the insert/dividers as a marking instrument for different pages of the book.

Preferably, the material used for the insert is a thin sheet of flexible plastic or paper.

### Example 4

### Ruler (207)

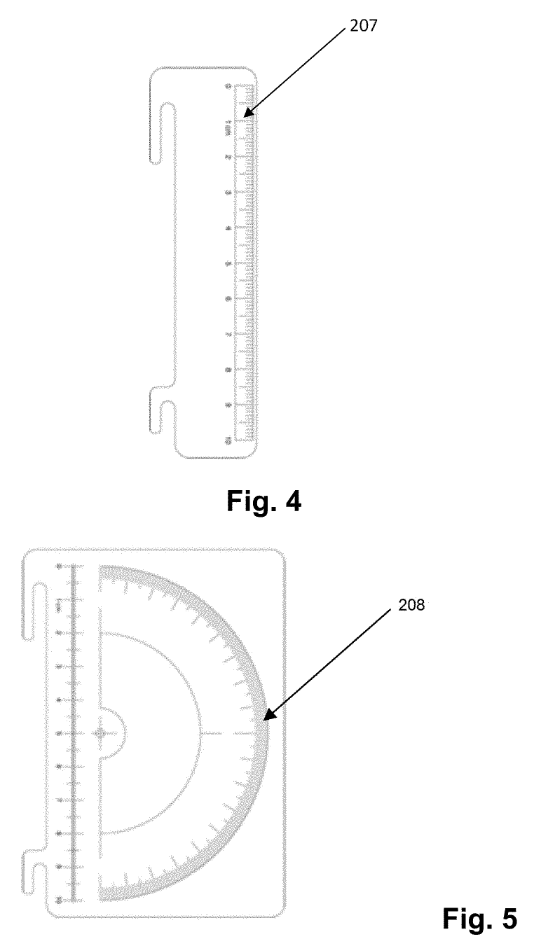

FIG. 4 illustrates another embodiment of the present invention, wherein the book insert of the present invention, apart from functioning as a bookmark for loop-bound (e.g. spiral-bound) books, also functions as a measuring device. For achieving this outcome, the elongated generally rectangular portion (body) (200), of the insert (100), is provided with ruler markings (207) printed on the surface thereof along or adjacent to one edge, preferably along or adjacent to one long edge, thereby acting as a ruler (207). In this way, distances, e.g. small-to-medium distances, can be measured using the ruler.

Preferably, as shown in FIG. 4, in the ruler (207), the ruler markings (207) are printed on the surface of the generally rectangular portion (body), along or adjacent to an edge (preferably a long edge) of the generally rectangular portion which is opposite to (i.e. faces directly away from) the edge (preferably long edge) of the generally rectangular portion (body) from which the first and second inserting members extend and/or project.

### Example 5

### Protractor (208)

FIG. 5 illustrates another embodiment of the present invention, wherein the book insert of the present invention, apart from functioning as a bookmark for loop-bound (e.g. spiral-bound) books, also functions as another measuring device and more particularly, a protractor (208). In this embodiment, the elongated generally rectangular portion (200), of the insert (100), is broader in breadth (and preferably also and longer in length), to accommodate the measurements of a protractor. In this way, angles can be measured using the protractor.

Preferably, as shown in FIG. 5, longitudinal ruler markings are also provided on the protractor (208), for measuring distances.

### Example 6

### Sticker (209)

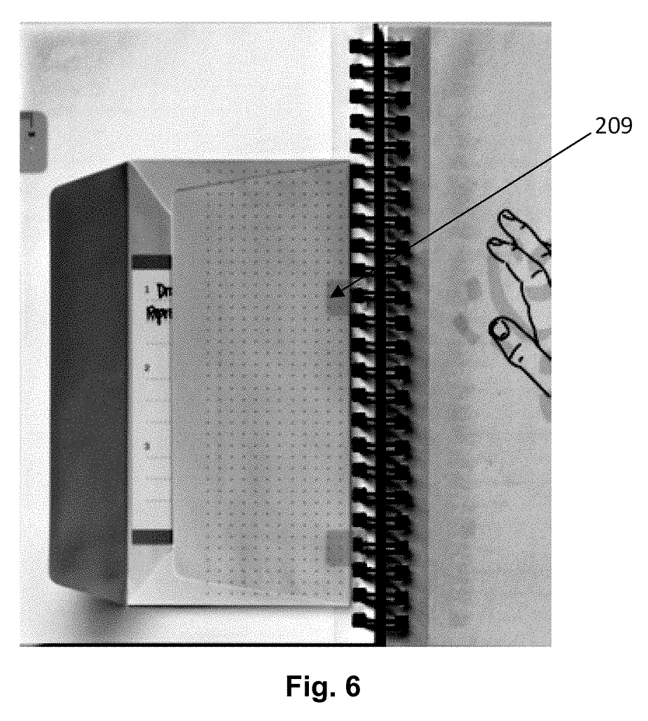

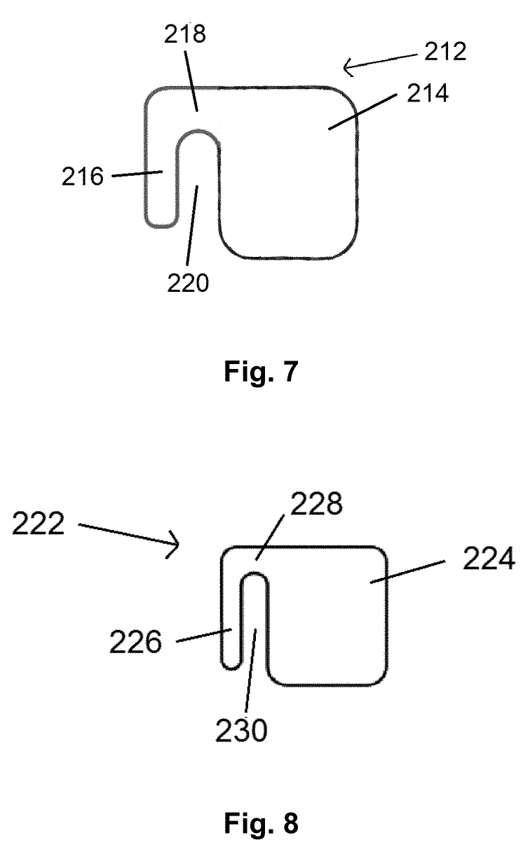

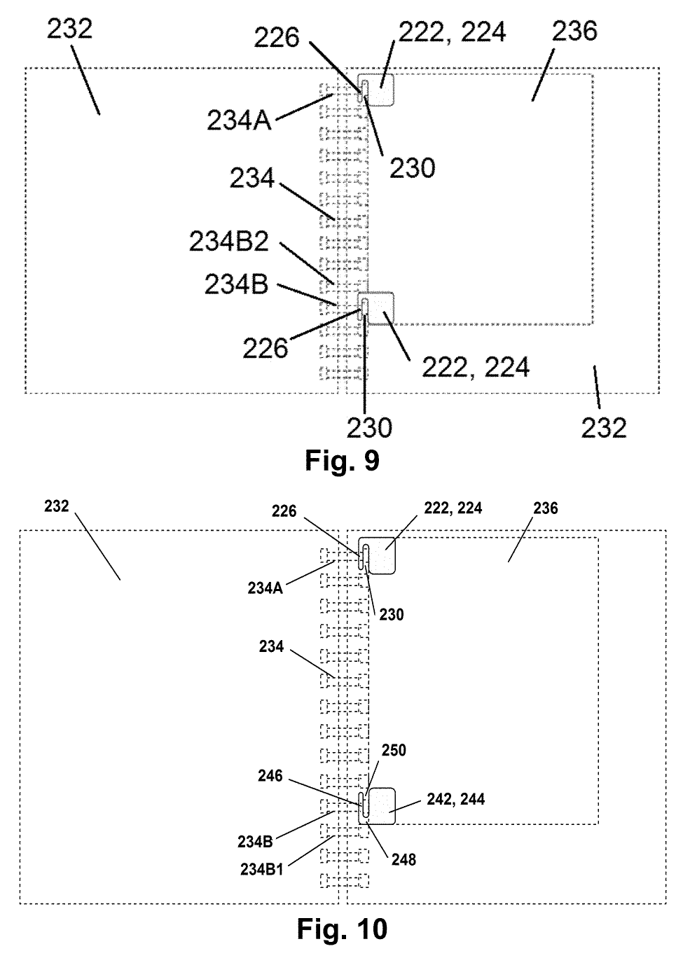

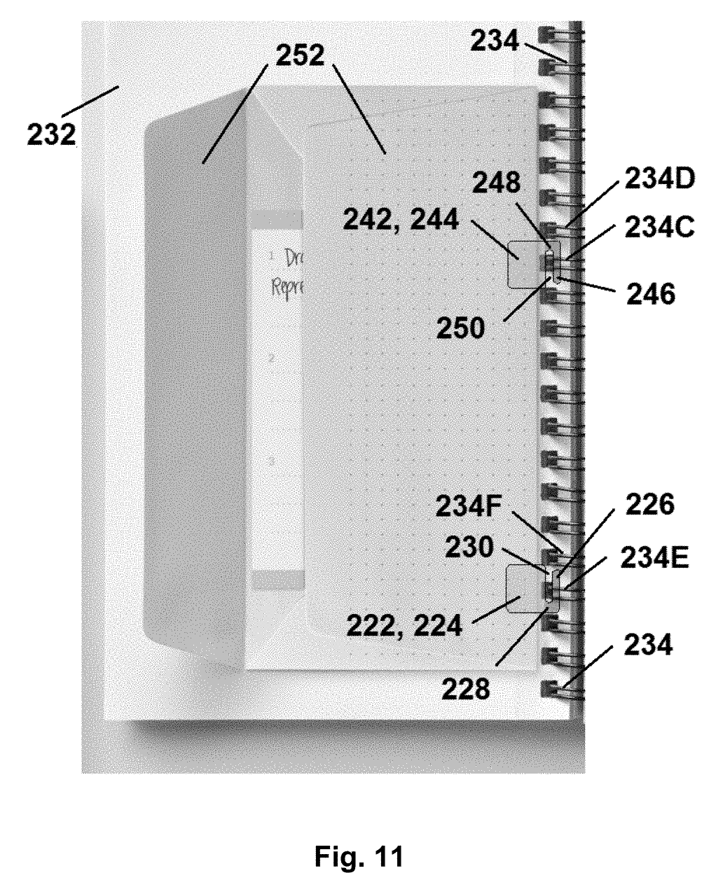

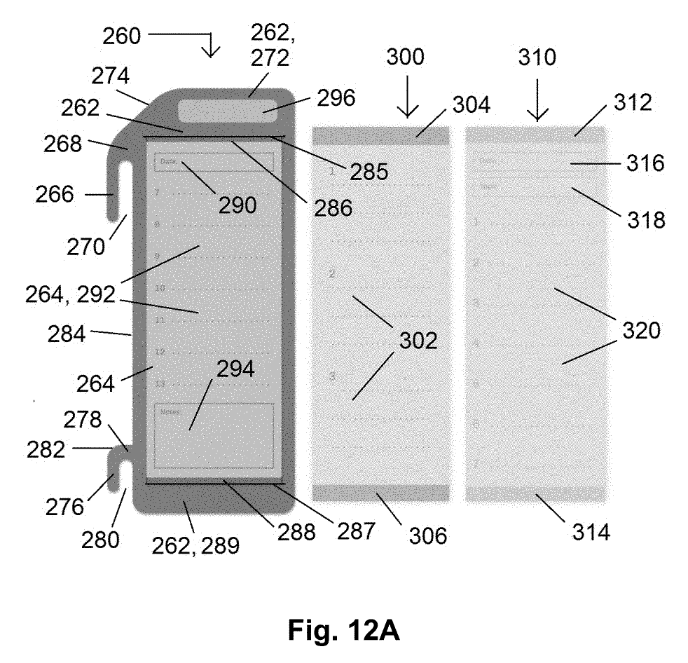

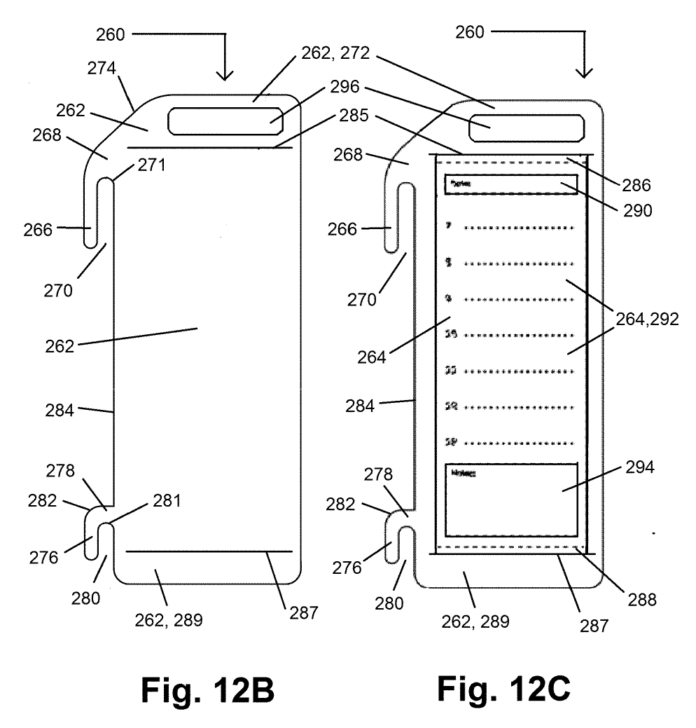

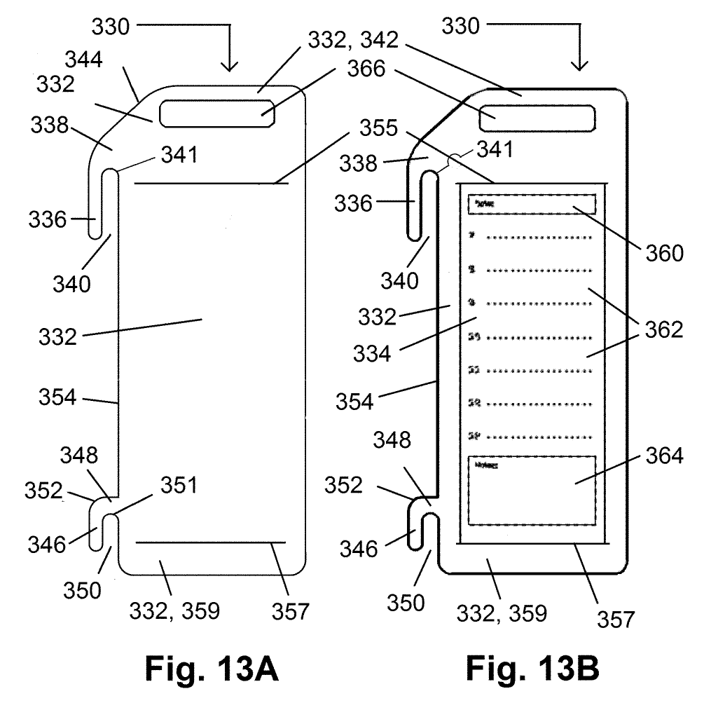

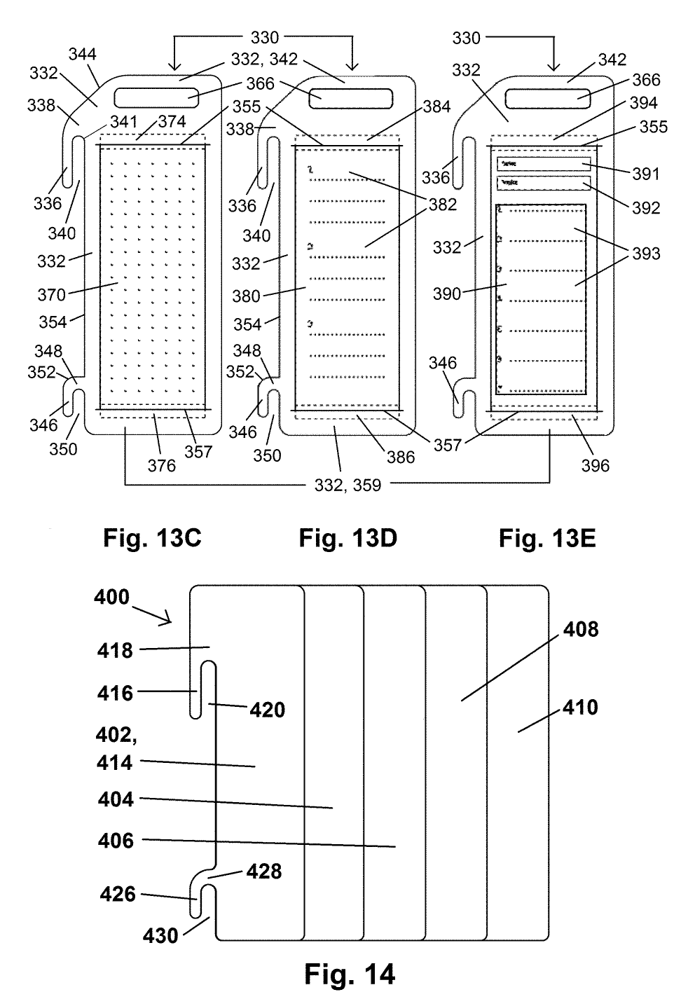

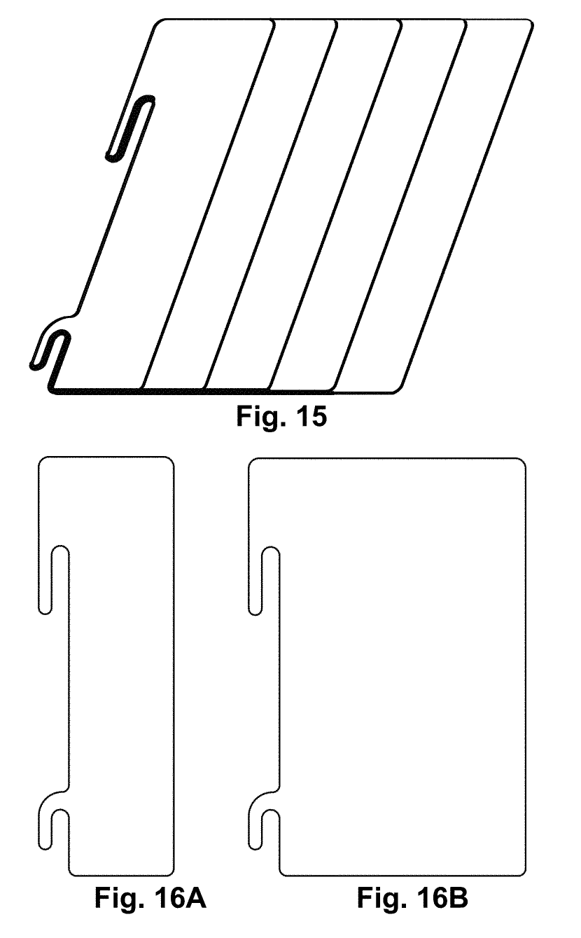

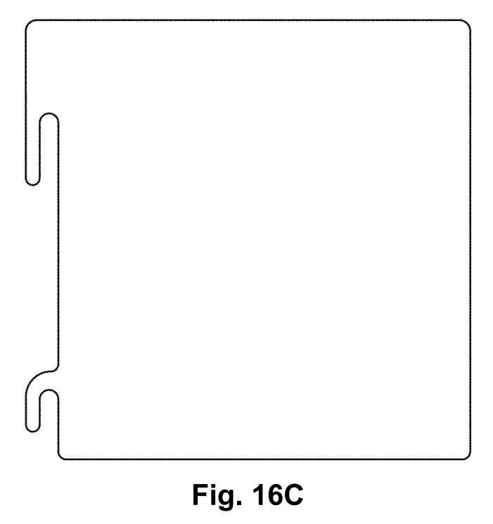

As mentioned hereinabove, FIG. 6 depicts a plan view from above of a book insert (sticker, 209) of present invention which functions as an attachment for various materials, as described in this Example 6. More particularly, FIG. 6 is a plan view from above of an open loop-bound (e.g. ring-bound, e.g. open-and-close ring-bound) book, into the binding of which has been inserted a book insert (sticker 209), wherein the sticker is attached to a piece of material (in FIG. 6, the piece of material is an envelope).

FIG. 6 illustrates another embodiment of the present invention (Example 6), wherein the book insert of the present invention comprises a sticky body (sticker) (209) for attachment of a piece or pieces, in particular a sheet or sheets, of material [preferably of sheet-like material and/or generally planar material, such as paper (preferably as a paper sheet or sheets), an envelope, and/or plastic (preferably as a plastic sheet or sheets)] to the loop-binding (e.g. spiral binding or ring binding) of the book, e.g. of a notebook.

In particular, the sticker (209) comprises a sticky body (209), and an insert which can be (i.e. which is capable of being) detachably coupled to the binding (binder) of a book, preferably to the binding (binder) of a loop-bound book such as a spiral-bound or ring-bound (e.g. open-and-dose ring-bound) book. Preferably, the insert comprises a detachable coupling means and/or an inserting member.

Preferably, as shown in FIG. 6, the insert and/or inserting member of the sticker (209), which is preferably elongate and/or narrow, continues (i.e. extends) from the top of the sticky body (209), and is aligned parallel to the adjacent edge of the sticky body, in such a way as to form a narrow gap between the sticky body (209) and the insert and/or inserting member, wherein the gap is to be inserted inside (i.e. is to receive) the loop binding (e.g. spiral binding) of the book.

Thus, preferably, in Example 6, the insert and/or inserting member of the sticker (209) is generally similar in form, position and/or orientation to the first inserting member (201) of the insert (100) of the Example 1 embodiment of the invention shown in FIG. 1. However, unlike Example 1, the sticker (209) of Example 6 functions as an attachment for various materials (such as an envelope, as shown in FIG. 6).

### Example 7

### Sticker (212)—FIG. 7

FIG. 7 illustrates another embodiment of the present invention (Example 7), which is a sticker 212, comprising a sticky body 214 for attachment of a piece or pieces, in particular a sheet or sheets, of material [preferably of sheet-like material and/or generally planar material, such as paper (preferably as a paper sheet or sheets), an envelope, and/or plastic (preferably as a plastic sheet or sheets)] to the loop-binding (e.g. spiral binding or ring binding) of the book, e.g. of a notebook.

In particular, the sticker 212 comprises a sticky body 214, and an insert 216 (a finger portion 216) which is capable of being detachably coupled to the binding (binder) of a loop-bound book such as a spiral-bound or ring-bound (e.g. open-and-close ring-bound) book. The insert 216 (the finger portion 216) is part of the detachable coupling means according to the first aspect of the invention.

As shown in FIG. 7, the finger portion 216 of the sticker 212, which is elongate (and generally narrow), extends from the top of the sticky body 212, and is aligned parallel to the adjacent edge of the sticky body 214, in such a way as to form a narrow gap 220 between the sticky body 214 and the finger portion 216, wherein the gap is to be inserted inside (i.e. is to receive) the loop binding (e.g. spiral binding) of the book.

The sticker 212 of Example 7 functions as an attachment for various materials (such as an envelope, similar to that shown in FIG. 6, & as shown in FIG. 11, or a sheet of paper e.g. as shown in FIGS. 9 and 10).

The sticker body (but not the finger portion) has adhesive on one side eg as defined herein.

### Example 8

### Sticker (222)—FIG. 8

This sticker is generally similar to Example 7, but the finger & gap is differently sized.

FIGS. 9-11—use of the sticker(s).

FIGS. 12A-16C—dividers.

A used herein, the terms “loop binding”, “loop binder”, “loop-bound” or similar terms, should be understood as meaning a binding system (or bound by a binding system) which loosely joins a sheaf or stack of pages (preferably pages of a book), wherein the binding system loops around and/or through holes (in particular sequential holes) on one edge of the pages. The binding system preferably comprises loops, typically a plurality of loops. The loops may be in a spiral (preferably a continual spiral); or the loops may be as separate, individual loops. Preferably, the loops are curved in some manner; and more preferably the loops are made from circles, rings, spirals, straight lines, and/or ellipses, and/or are made from portions of circles, rings, spirals, straight lines, and/or ellipses. For example, “ring binding”, typically as or in a multi ring binding system and/or a ring binder such as a two-ring or three-ring binder (preferably a binder having a plurality of, more preferably two or three, openable and closable rings; and/or preferably an open-and-dose ring binder), would be included as a preferred embodiment of “loop binding”. Other examples, which are alternative and/or additional preferred embodiments of “loop binding”, include comb binding, spiral binding (also called coil binding), and/or wire binding.

The bookmark, insert (preferably book insert), divider and/or sticker may be made out of a wide variety of materials. It is particularly economical and desirable to make it out of a non-brittle and/or flexible plastic (preferably a non-brittle and/or flexible plastic which is a common plastic and/or which is a flexible plastic as defined herein, preferably PET, PBT, PTT, PEN, another polyester (preferably a biodegradable polyester), PVC, PP, PE and/or other plastic(s) as defined herein). However, various kinds of paper and/or cardboard may also be used satisfactorily.

Having described the invention in detail and by reference to the preferred embodiments, it will be apparent that modifications and variations thereof are possible without departing from the scope of the invention. For example, although the preferred embodiment of the invention is described in relation to its use to engage the loop-binding (loop-binders) of the book, in the form of ring binders or binding coils (spiral binding), it would be appreciated that it is also applicable to other forms of loop binding, such as comb binding and/or wire binding.

1. A sticker suitable for inserting into a loop-bound book, comprising:
(i) a detachable coupling means, which can be (i.e. which is capable of being) detachably coupled to the binding of a loop-bound book; and
(ii) a sticky body for attachment to a material;
wherein the sticker is capable of functioning as an attachment for attaching the material to the loop binding of the book.

2. A sticker as claimed in claim 1, wherein the sticky body is suitable for attachment to a material comprising a sheet and/or to a generally planar material.

3. A sticker as claimed in claim 1, wherein the body of the sticker is in the form of a sheet, preferably a flexible sheet, and/or is generally planar.

4. A sticker as claimed in claim 3, wherein the sticky body contains, or the body of the sticker excluding any adhesive is at least partially covered by, an adhesive on one face of the sheet of the body and/or on one face of the generally planar body.

5. A sticker as claimed in claim 1, wherein the detachable coupling means of the sticker is not covered by an adhesive.

6. A sticker as claimed in claim 1, wherein an adhesive, and/or the application or distribution pattern of an adhesive, on one face of a sheet of the body and/or on one face of a generally planar body, is such that the sticker can be removed from the material, preferably substantially without damaging the material, in particular without tearing or delaminating the material.

7. A sticker as claimed in claim 6, wherein the adhesive, and/or the application or distribution pattern of the adhesive, is such that, after removal from the material, the sticker can then be repositioned and re-stuck to the material.

8. A sticker as claimed in claim 4, wherein the chemical composition of the adhesive, and/or the manner and/or pattern in or by which the adhesive has been applied to and/or distributed around the one face of the sheet of the body and/or of the generally planar body, is such that:
the sticker can be removed from the material, preferably substantially without damaging the material, in particular without tearing or delaminating the material; and
the sticker can then be repositioned and re-stuck to the material.

9. A sticker as claimed in claim 4, wherein the adhesive is a pressure-sensitive adhesive.

10. A sticker as claimed in claim 4, wherein the adhesive is a removeable and re-stickable adhesive; and/or wherein the application or distribution pattern of the adhesive achieves said removeability and re-stickability.

11. A sticker as claimed in claim 1, wherein the detachable coupling means is elongate; and wherein the detachable coupling means and the body together form a gap between the detachable coupling means and the body,
wherein the gap is adapted to receive the loop binding of the book, and/or wherein the gap is adapted so that the loop binding of the book can be inserted inside the gap.

12. A sticker as claimed in claim 1, wherein the detachable coupling means is elongate and comprises a finger portion which is capable of being detachably coupled to the binding of the loop-bound book.

13. A sticker as claimed in claim 12, wherein the finger portion is aligned generally parallel to the body and/or to a side of the body; and the finger portion is connected to the body via a stem portion.

14. A sticker as claimed in claim 1, wherein the detachable coupling means is integrally formed with the body.

15. A sticker as claimed in claim 1, wherein the detachable coupling means is elongate and comprises a finger portion which is capable of being detachably coupled to the binding of a loop-bound book, wherein:
the finger portion is aligned generally parallel to the body and/or to an adjacent side of the body; and
the finger portion of the elongate detachable coupling means and the body together form a gap between the finger portion and the body, wherein the gap is adapted to receive the loop binding of the book; and
the finger portion has a width of from 1.5 to 6 mm, or preferably from 2 to 5 mm, more preferably from 2 to 4.5 mm, or even more preferably from 2.5 to 4 mm;
and
the finger portion has a length of from 5 to 45 mm, preferably from 7 to 30 mm, more preferably from 9 to 25 mm;
wherein the length of the finger portion is measured, in a direction parallel to a longitudinal axis of the finger portion and/or in a direction parallel to an adjacent edge of the body, from (i) an outer tip of the finger portion to (ii) the innermost portion of the gap between the finger portion and the body, and/or, from (i) an outer tip of the finger portion to (ii) to the point where an inner edge of the finger portion, or an inner edge of a or the stem portion connecting the finger portion to the body, extends and/or projects from the body.

16. A sticker as claimed in claim 1, wherein the body of the sticker is in the form of a sheet and/or is generally planar; and the body of the sticker has a height of from 5 to 100 mm and/or a width of from 5 to 100 mm; or preferably has a height of from 8 to 60 mm and/or a width of from 8 to 60 mm.

17. A sticker as claimed in claim 1, wherein the body of the sticker, being the sticky body or the body before addition of any adhesive, is in the form of a sheet and/or is generally planar; and the body of the sticker has a thickness of from 0.05 to 1 mm, or preferably has a thickness of from 0.05 to 0.5 mm, or more preferably has a thickness of from 0.2 to 1 mm or from 0.2 to 0.5 mm.

18. A sticker as claimed in claim 1, wherein the body of the sticker, being the sticky body or the body before addition of any adhesive, is in the form of a sheet and/or is generally planar; and the body of the sticker has a thickness of from 0.25 to 1 mm, or preferably has a thickness of from 0.25 to 0.5 mm, or more preferably has a thickness of from 0.3 to 0.5 mm.

19. A sticker as claimed in claim 1, wherein
the sticker, and/or the sticker's detachable coupling means and/or the sticker's body, is made out of a flexible plastic, wherein the flexible plastic comprises:
(i) a flexible polyester;
(ii) a flexible polyvinyl chloride (PVC);
(iii) a flexible polypropylene (PP);
(iv) a flexible polyethylene (PE)
and/or
(v) a flexible acrylate-polymer-based plastic;
and/or
(vi) a flexible copolymer of, or containing, one or more of the polymers (i), (ii) (iii), (iv) and/or (v).

20. A sticker as claimed in claim 19, wherein:
the sticker, and/or the sticker's detachable coupling means and/or the sticker's body, is made out of a flexible plastic, wherein the flexible plastic comprises:
(i) a flexible polyester comprising (e.g. being):
a flexible poly(ethylene terephthalate) (PET), a flexible poly(butylene terephthalate) (PBT), a flexible poly(trimethylene terephthalate) (PTT), a flexible poly(ethylene naphthalate) (PEN), a flexible poly(hydroxyalkanoate) (PHA), a flexible poly-ε-caprolactone (PCL) (wherein ε is epsilon), a flexible poly(lactic acid) (PLA), a flexible poly(glycolic acid) (PGA), a flexible poly(ethylene succinate) (PESu), a flexible poly(propylene succinate) (PPSu), a flexible poly(butylene succinate) (PBSu), a flexible poly(ethylene adipate) (PEA) and/or a flexible poly(butylene adipate) (PBA);
(ii) a flexible polyvinyl chloride (PVC);
(iii) a flexible polypropylene (PP);
(iv) a flexible polyethylene (PE), wherein the flexible polyethylene is:
a flexible high-density polyethylene (HDPE, defined by a density of greater than or equal to 0.941 g/cm³),
a flexible medium-density polyethylene (MDPE, defined by a density range of from 0.926 to 0.940 g/cm³),
a flexible low-density polyethylene (LDPE, defined by a density range of from 0.910 to 0.940 g/cm³),
a flexible linear low-density polyethylene (LLDPE, which is a substantially linear polyethylene and/or which is defined by a density range of from 0.915 to 0.925 g/cm³), and/or
a flexible very-low-density polyethylene (VLDPE, defined by a density range of from 0.880 to 0.915 g/cm³; and being a substantially linear polymer containing some C₁-C₈alkyl branches);
and/or
(v) a flexible acrylate-polymer-based plastic, which comprises a flexible polyacrylic-acid-based plastic, a flexible poly(methyl acrylate) plastic, a flexible polyethyl acrylate) plastic, a flexible poly(methacrylate) plastic and/or a flexible poly(methyl methacrylate) plastic;
and/or
(vi) a flexible copolymer which is a flexible polypropylene-polyethylene copolymer (PP-PE), a flexible ethylene-vinyl acetate (EVA) copolymer, a flexible poly(3-hydroxybutyrate-co-3-hydroxyvalerate) (PHBV), a flexible poly(3-hydroxybutyrate-co-3-hydroxyhexanoate) (PHBH), and/or a flexible poly(butylene adipate-co-terephthalate) (PBAT).

21. A sticker as claimed in claim 1, which is in the form of a plurality of stickers forming a pad.

22. A method of removeably attaching a sticker, as defined in claim 1,
to the binding of a loop-bound book; the method comprising removeably inserting, into the loop binding of the book, the detachable coupling means as defined in claim 1 and which is elongate; and/or
to sheet material and/or to generally planar material; the method comprising removeably attaching the sticky body to the material.

23. A combination, comprising one, two or more stickers, as defined in claim 1,
wherein the one, two or more stickers are attached via the sticky body(ies) thereof to a material, wherein the material comprises a sheet and/or is a generally planar material;
and wherein, optionally, the one, two or more stickers are also attached to the binding of a loop-bound book via the detachable coupling means.
